(19) United States
(12) Patent Application Publication
(10) Pub. No.: US 2025/0330639 A1
(43) Pub. Date: Oct. 23, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Kai ZHANG, Los Angeles, CA (US); Li ZHANG, Los Angeles, CA (US)

(21) Appl. No.: 19/255,965

(22) Filed: Jun. 30, 2025

Related U.S. Application Data
(63) Continuation of application No. PCT/CN2023/143502, filed on Dec. 29, 2023.

(30) Foreign Application Priority Data
Dec. 30, 2022 (WO) PCT/CN2022/143679

(51) Int. Cl. H04N 19/577; H04N 19/105; H04N 19/139; H04N 19/172; H04N 19/513; H04N 19/54

(52) U.S. Cl. CPC H04N 19/577; H04N 19/105; H04N 19/139; H04N 19/172; H04N 19/521; H04N 19/54

(57) ABSTRACT

Embodiments of the present disclosure provide a solution for video processing. A method for video processing is proposed. In the method, for a conversion between a current video block of a video and a bitstream of the video, affine information associated with a single prediction direction or a single reference picture list of the current video block with an affine motion is determined. The current video block is coded by at least one of: a bi-prediction mode, a multiple-hypothesis mode, or a uni-prediction mode. A refinement process is applied to the affine information to obtain refined affine information. The conversion is performed based on the refined affine information.

### CROSS REFERENCE TO RELATED APPLICATIONS

This application is a continuation of International Application No. PCT/CN2023/143502, filed on Dec. 29, 2023, which claims the benefit of International Application No. PCT/CN2022/143679 filed on Dec. 30, 2022. The entire contents of these applications are hereby incorporated by reference in their entireties.

### FIELDS

Embodiments of the present disclosure relates generally to video processing techniques, and more particularly, to inter prediction enhancement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, affine information associated with a single prediction direction or a single reference picture list of the current video block with an affine motion, the current video block being coded by at least one of: a bi-prediction mode, a multiple-hypothesis mode, or a uni-prediction mode; applying a refinement process to the affine information to obtain refined affine information; and performing the conversion based on the refined affine information. The method in accordance with the first aspect of the present disclosure refines affine in a single prediction direction or in a single reference picture list. In this way, the coding effectiveness and coding efficiency can be improved.

In a second aspect, another method for video processing is proposed. The method comprises: determining, for a conversion between a current video block of a video and a bitstream of the video, an inter prediction of the current video block coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; and performing the conversion based on the inter prediction. The method in accordance with the second aspect of the present disclosure determines the inter prediction for the CIIP mode by using various kinds of processes. In this way, the coding effectiveness and coding efficiency can be improved.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining affine information associated with a single prediction direction or a single reference picture list of a current video block of the video, the current video block being with an affine motion and being coded by at least one of: a bi-prediction mode, a multiple-hypothesis mode, or a uni-prediction mode; applying a refinement process to the affine information to obtain refined affine information; and generating the bitstream based on the refined affine information.

In a sixth aspect, a method for storing a bitstream of a video is proposed. The method comprises: determining affine information associated with a single prediction direction or a single reference picture list of a current video block of the video, the current video block being with an affine motion and being coded by at least one of: a bi-prediction mode, a multiple-hypothesis mode, or a uni-prediction mode; applying a refinement process to the affine information to obtain refined affine information; generating the bitstream based on the refined affine information; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining an inter prediction of a current video block of the video, the current video block being coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; and generating the bitstream based on the inter prediction.

In an eighth aspect, a method for storing a bitstream of a video is proposed. The method comprises: determining an inter prediction of a current video block of the video, the current video block being coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; generating the bitstream based on the inter prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A and FIG. 4B illustrate control point based affine motion models, where FIG. 4A illustrates a 4-parameter affine model, and FIG. 4B illustrates a 6-parameter affine model;

FIG. 5 illustrates affine MVF per subblock;

FIG. 6 illustrates locations of inherited affine motion predictors;

FIG. 7 illustrates control point motion vector inheritance;

FIG. 8 illustrates locations of candidates position for constructed affine merge mode;

FIG. 9 illustrates an illustration of motion vector usage for proposed combined method;

FIG. 10 illustrates subblock MV VSB and pixel Δv(i,j) (small arrow);

FIGS. 11A and 11B illustrate the SbTMVP process in VVC, where FIG. 11A illustrates spatial neighboring blocks used by ATVMP, and FIG. 11B illustrates deriving sub-CU motion field by applying a motion shift from spatial neighbor and scaling the motion information from the corresponding collocated sub-CUs;

FIG. 12 illustrates a first HPT and a second HPT;

FIG. 13 illustrates spatial neighbors for deriving affine merge/AMVP candidates: (a) for deriving inherited candidates (b) for deriving the first type of constructed candidates;

FIG. 14 illustrates an example diagram from non-adjacent neighbors to the first type of constructed affine merge/AMVP candidates;

FIG. 15 illustrates illustration of the neighboring 4×4 subblocks that are used for RMVF parameter derivation. W and H are the width and height of the current CU;

FIG. 16 illustrates planar motion vector prediction process;

FIG. 17A to FIG. 17D illustrate examples of translational and non-translational motion, where FIG. 17A illustrates a translational motion which can be represented by BMME, FIG. 17B illustrates a zoom and rotation which can be represented by four-parameter affine model with two control points, FIG. 17C illustrates a regular deformation motion which can be represented by six-parameter affine model with three control points, and FIG. 17D illustrates a irregular deformation motion which can be represented by bilinear interpolation model with four control points;

FIG. 18A illustrates candidate positions for predicting the motion information of each control point of a block for spatial neighbors;

FIG. 18B illustrates candidate positions for predicting the motion information of each control point of a block for temporal neighbor;

FIG. 19 illustrates sketch map of bilinear interpolation model for a 16×16 block;

FIG. 20 illustrates the reference samples used in planar mode;

FIG. 21 illustrates positions of spatial merge candidate;

FIG. 22 illustrates candidate pairs considered for redundancy check of spatial merge candidates;

FIG. 23 illustrates an illustration of motion vector scaling for temporal merge candidate;

FIG. 24 illustrates candidate positions for temporal merge candidate, C0 and C1;

FIG. 25 illustrates VVC spatial neighboring blocks of the current block;

FIG. 26 illustrates an illustration of virtual block in the i-th search round;

FIG. 27 illustrates spatial neighboring blocks used to derive the spatial merge candidates;

FIG. 28 illustrates non-adjacent temporal neighboring blocks used to derive the non-adjacent temporal merge candidates;

FIG. 29A to FIG. 29C illustrate three stages of non-translation parameters search, respectively;

FIG. 30 illustrates sub-block processing for affine DMVR;

FIG. 31 illustrates illustration of independent bilateral matching search for CPMVs;

FIG. 32 illustrates top and left neighboring blocks used in CIIP weight derivation;

FIG. 33 illustrates decoding side motion vector refinement;

FIG. 34 illustrates diamond regions in the search area;

FIG. 35 illustrates an extended CU region used in BDOF;

FIG. 36 illustrates a control point motion vector;

FIG. 37 illustrates a flowchart of a method for video processing in accordance with embodiments of the present disclosure;

FIG. 38 illustrates a flowchart of a method for video processing in accordance with embodiments of the present disclosure;

FIG. 39 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

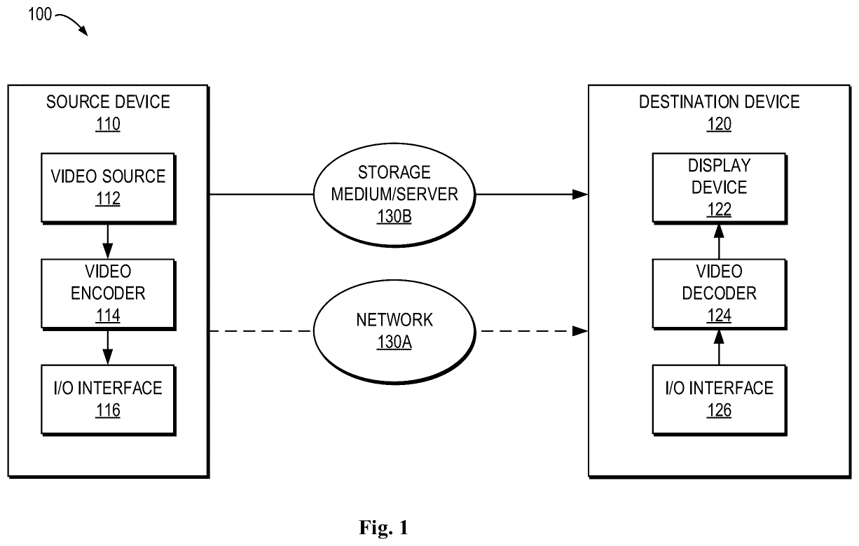

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

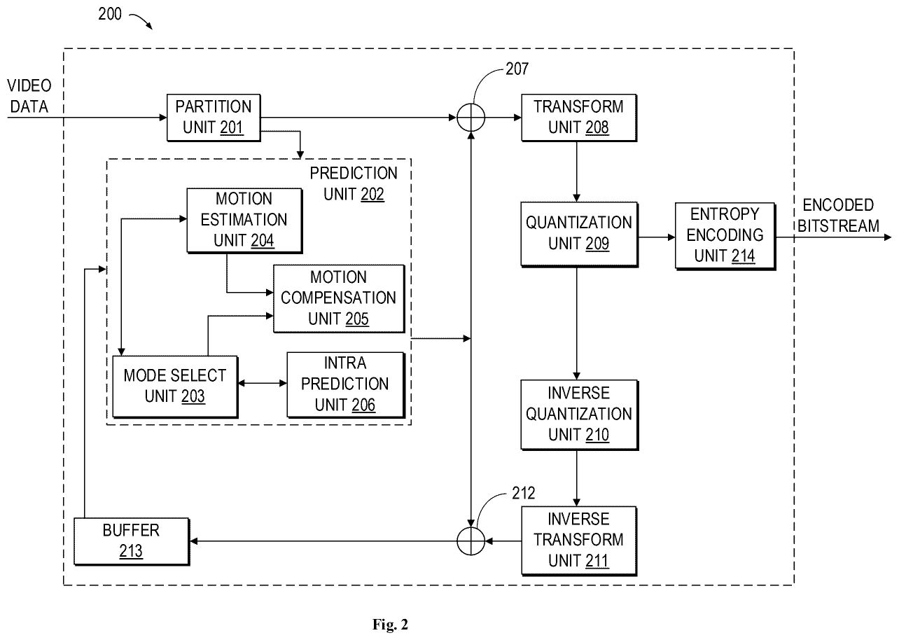

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

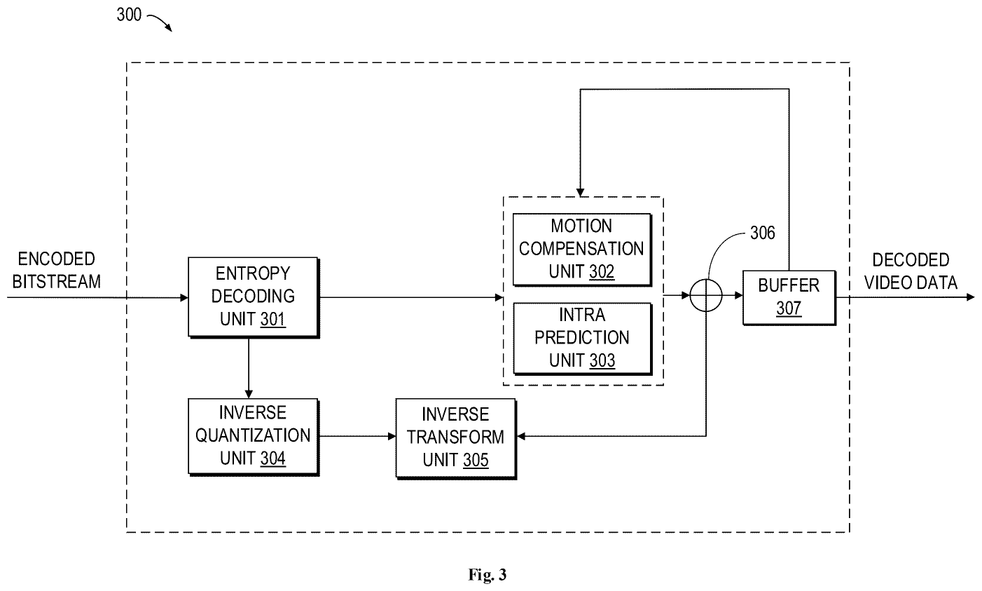

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to image/video coding, especially on adaptive affine decoder side motion vector refinement (DMVR) and combined inter and intra prediction (CIIP). It may be applied to the existing video coding standard like HEVC, or the standard VVC (Versatile Video Coding). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.

To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

In January 2021, JVET established an Exploration Experiment (EE), targeting at enhanced compression efficiency beyond VVC capability with novel traditional algorithms. Soon later, ECM was built as the common software base for longer-term exploration work towards the next generation video coding standard.

### 2.1. Affine Motion Compensated Prediction

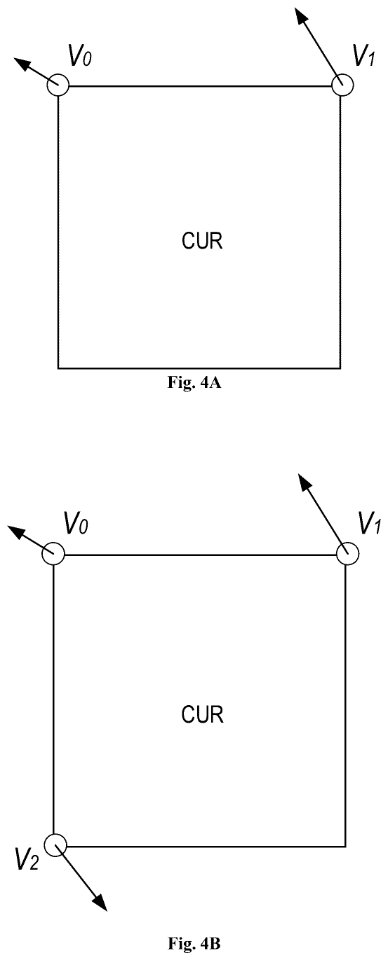

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 4A and FIG. 4B illustrate control point based affine motion models, where FIG. 4A illustrates a 4-parameter affine model, and FIG. 4B illustrates a 6-parameter affine model. As shown in FIG. 4A and FIG. 4B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} . \qquad ( 2 - 1 )$$

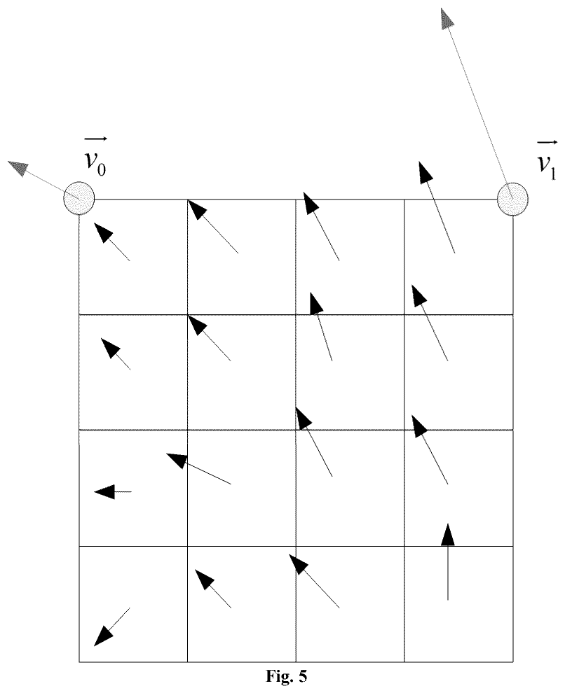

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} . \qquad ( 2 - 2 )$$

Where (mν₀ₓ, mν_{0y}) is motion vector of the top-left corner control point, (mν₁ₓ, mν_{1y}) is motion vector of the top-right corner control point, and (mν₂ₓ, mν_{2y}) is motion vector of the bottom-left corner control point. In order to simplify the motion compensation prediction, block based affine transform prediction is applied. FIG. 5 illustrates affine MVF per subblock. To derive motion vector of each 4×4 luma subblock, the motion vector of the center sample of each subblock, as shown in FIG. 5, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.1.1. Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPMV candidate are used to form the affine merge candidate list:
Inherited affine merge candidates that extrapolated from the CPMVs of the neighbour CUs,
Constructed affine merge candidates CPMVPs that are derived using the translational MVs of the neighbour CUs,
Zero MVs.

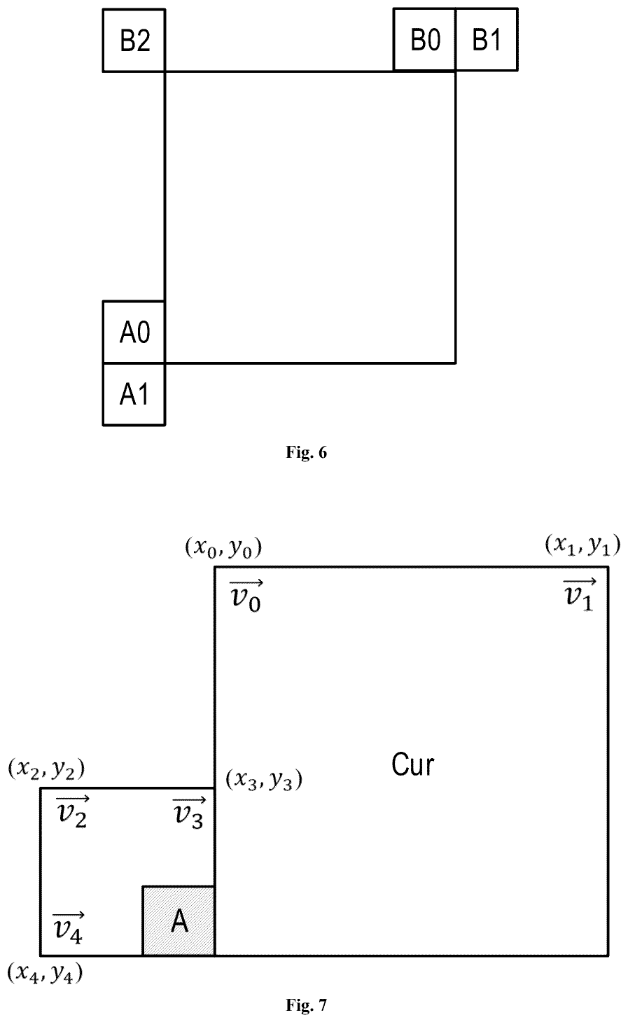

In VVC, there are maximum two inherited affine candidates, which are derived from affine motion model of the neighboring blocks, one from left neighboring CUs and one from above neighboring CUs. The candidate blocks are shown in FIG. 6 which illustrates locations of inherited affine motion predictors. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. As shown in FIG. 7 which illustrates control point motion vector inheritance, if the neighbour left bottom block A is coded in affine mode, the motion vectors v₂, V₃ and v₄ of the top left corner, above right corner and left bottom corner of the CU which contains the block A are attained.

When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

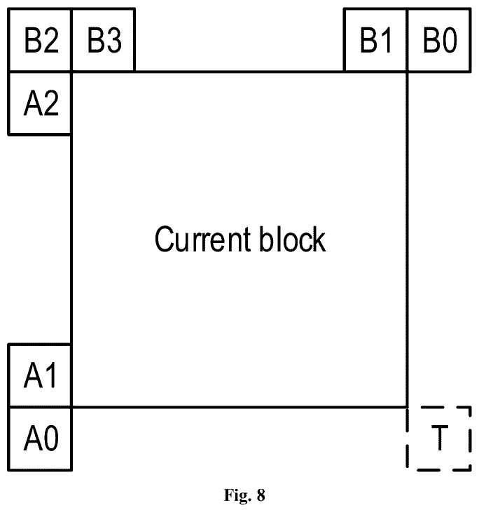

Constructed affine candidate means the candidate is constructed by combining the neighbor translational motion information of each control point. The motion information for the control points is derived from the specified spatial neighbors and temporal neighbor shown in FIG. 8 which illustrates locations of candidates position for constructed affine merge mode. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available. After MVs of four control points are attained, affine merge candidates are constructed based on those motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.1.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs,
Constructed affine AMVP candidates CPMVPs that are derived using the translational MVs of the neighbour CUs,
Translational MVs from neighboring CUs,
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 8. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable. If affine AMVP list candidates is still less than 2 after valid inherited affine AMVP candidates and constructed AMVP candidate are inserted, mv₀, mv₁ and mv₂ will be added, in order, as the translational MVs to predict all control point MVs of the current CU, when available. Finally, zero MVs are used to fill the affine AMVP list if it is still not full.

### 2.1.3. Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and deblocking.

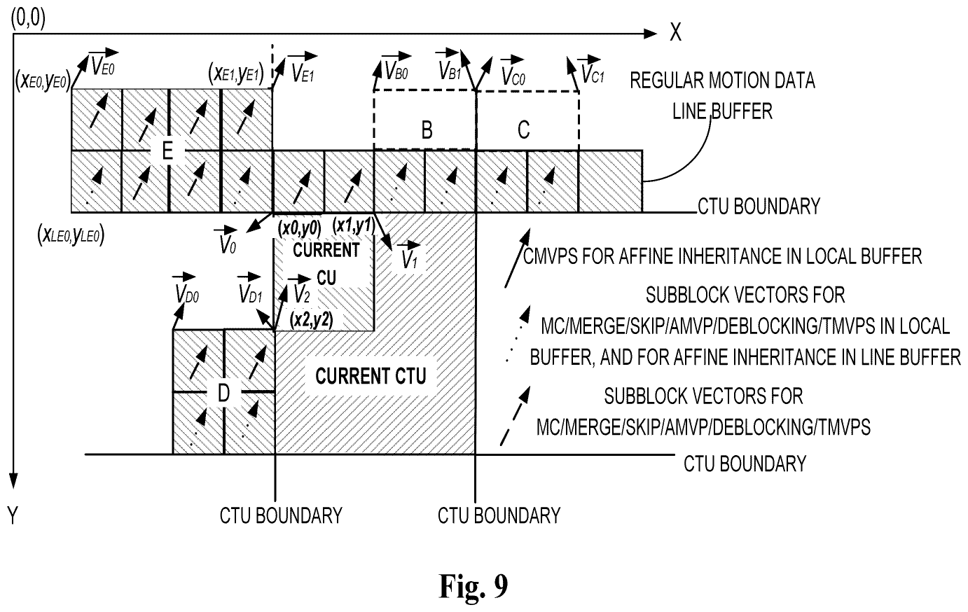

To avoid the picture line buffer for the additional CPMVs, affine motion data inheritance from the CUs from above CTU is treated differently to the inheritance from the normal neighboring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 9 which illustrates an illustration of motion vector usage for proposed combined method, along the top CTU boundary, the bottom-left and bottom right subblock motion vectors of a CU are used for affine inheritance of the CUs in bottom CTUs.

### 2.1.4. Prediction Refinement With Optical Flow for Affine Mode

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:

Step 1) The subblock-based affine motion compensation is performed to generate subblock prediction I(i, j).

Step2) The spatial gradients gₓ(i, j) and g_{y}(i, j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) >> shift 1 ) - ( I ( i - 1 , j ) >> shift 1 ) \qquad ( 2 - 3 )$$

$${g}_{y} ( i , j ) = ( I ( i , j + 1 ) >> shift 1 ) - ( I ( i , j - 1 ) >> shift 1 ) \qquad ( 2 - 4 )$$

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

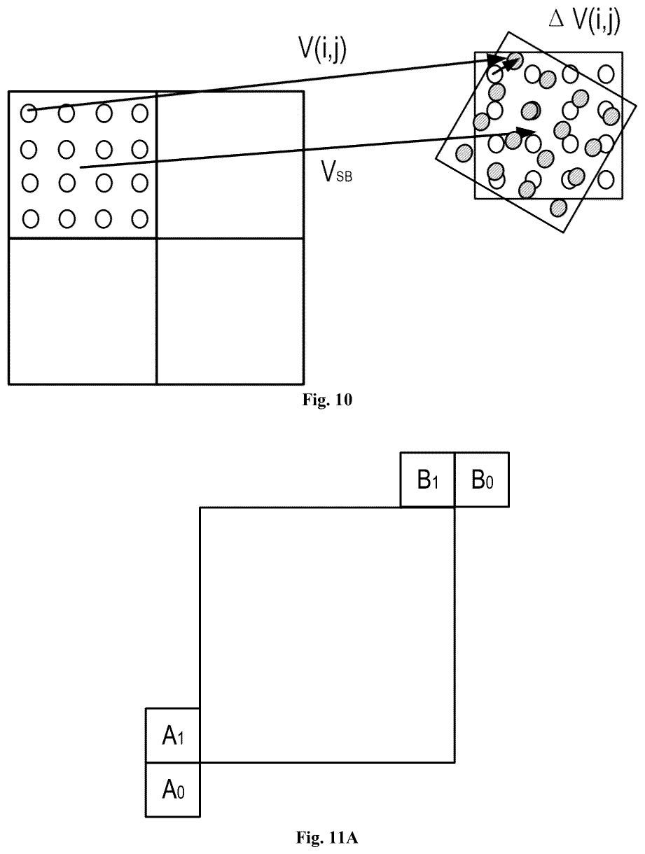

Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 5 )$$

where the Δv(i, j) is the difference between sample MV computed for sample location (i, j), denoted by v(i, j), and the subblock MV of the subblock to which sample (i, j) belongs, as shown in FIG. 10 which illustrates subblock MV VSB and pixel Δv(i,j) (small arrow). The Δv(i, j) is quantized in the unit of 1/32 luam sample precision.

Since the affine model parameters and the sample location relative to the subblock center are not changed from subblock to subblock, Δv(i, j) can be calculated for the first subblock, and reused for other subblocks in the same CU. Let dx(i, j) and dy(i, j) be the horizontal and vertical offset from the sample location (i, j) to the center of the subblock (x_{SB}, y_{SB}), Δv(x, y) can be derived by the following equation,

$$\{ \begin{matrix}dx ( i , j ) = i - {x}_{SB} \\ dy ( i , j ) = j - {y}_{SB}\end{matrix} , \qquad ( 2 - 6 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} . \qquad ( 2 - 7 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively. For 4-parameter affine model,

$$\{ \begin{matrix}C = F = \frac{{v}_{1 x} - {v}_{0 x}}{w} \\ E = - D = \frac{{v}_{1 Y} - {v}_{0 Y}}{w}\end{matrix} . \qquad ( 2 - 8 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} . \qquad ( 2 - 9 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI (i, j) is added to the subblock prediction I (i, j). The final prediction I′ is generated as the following equation.

I′(i,j)=I(i,j)+ΔI(i,j).

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.1.5. Adaptive Bypass of Affine ME

If enabled using the VTM encoder parameter AdaptBypassAffineMe, adaptive bypass of affine ME is used as an encoder only operation used to speed up encoding.

Before performing affine ME for a CU, the coding modes of its five spatial neighbours (above, left, above-right, bottom-left, above-left) are checked. If the number of available neighbours is greater than or equal to 4 and none of them are coded as affine or SbTMVP mode, affine ME is bypassed. In addition following two conditions are considered.
1) If a CU is no larger than 16×16, affine ME is not bypassed.
2) If the best mode for a CU is affine merge so far, and the current picture does not have symmetric reference pair (SMVD condition) or the absolute temporal distance between the current picture and SMVD reference is larger than 1, affine ME is not bypassed.

### 2.2. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

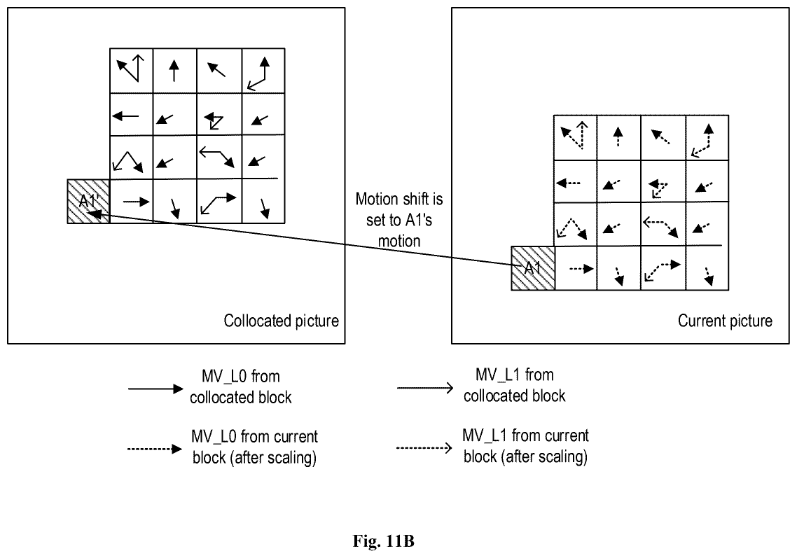

The SbTVMP process is illustrated in FIG. 11A and FIG. 11B. FIG. 11A illustrates spatial neighboring blocks used by ATVMP. FIG. 11B illustrates deriving sub-CU motion field by applying a motion shift from spatial neighbor and scaling the motion information from the corresponding collocated sub-CUs. SbTMVP predicts the motion vectors of the sub-CUs within the current CU in two steps. In the first step, the spatial neighbor A1 in FIG. 11A is examined. If Al has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 11B. The example in FIG. 11B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.3. History-Parameter-Based Affine Model Inheritance and Non-Adjacent Affine Mode

History-parameter-based affine model inheritance (HAMI) allows the affine model to be inherited from a previously affine-coded block which may not be neighboring to the current block. Similar to the enhanced regular merge mode, non-adjacent affine mode (NA-AFF) is introduced.

A first history-parameter table (HPT) is established. An entry of the first HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) ,$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefList_{cur} and RefIdx_{cur}, the affine parameters are utilized to update entries in the category HPTCat(RefList_{cur}, RefIdx_{cur}) in a way similar to HMVP table updating.

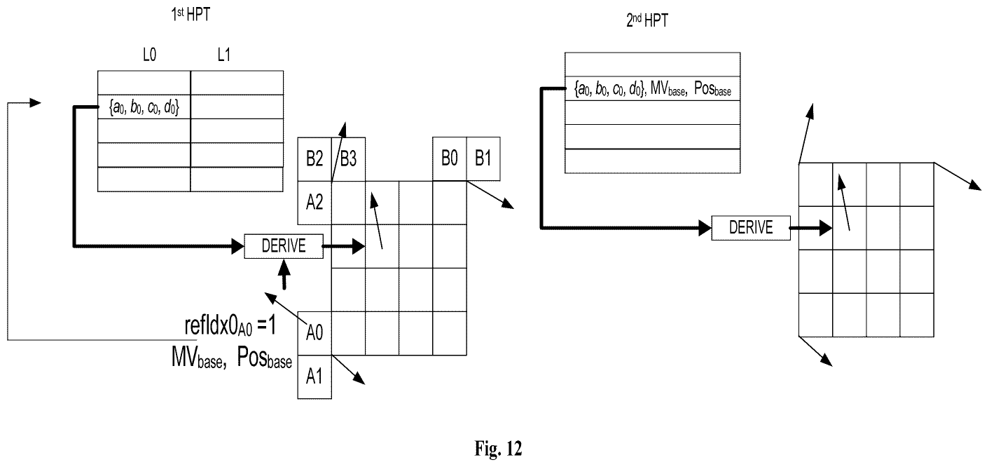

A history-affine-parameter-based candidate (HAPC) is derived from one of the seven neighbouring 4×4 blocks denoted as A0, A1, A2, BO, B1, B2 or B3 in FIG. 12 and a set of affine parameters stored in a corresponding entry in the first HPT. The MV of a neighbouring 4×4 block served as the base MV. In a formulating way, the MV of the current block at position (x, y) is calculated as:

$$\{ \begin{matrix}m {v}^{h} ( x , y ) = a ( x - {x}_{base} ) + c ( y - {y}_{base} ) + m {v}_{base}^{h} \\ m {v}^{v} ( x , y ) = b ( x - {x}_{base} ) + d ( y - {y}_{base} ) + m {v}_{base}^{v}\end{matrix} .$$

where (mv^{h}base, mv^{v}base) represents the MV of the neighbouring 4×4 block, (x_{base}, y_{base}) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

A second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT and the second HPT is illustrated in FIG. 12 which illustrates a first HPT and a second HPT.

Moreover, pair-wised affine merge candidates are generated by two affine merge candidates which are history-derived or not history-derived. A pair-wised affine merge candidates is generated by averaging the CPMVs of existing affine merge candidates in the list.

As a response to new HAPCs being introduced, the size of sub-block-based merge candidate list is increased from five to fifteen, which are all involved in the ARMC process.

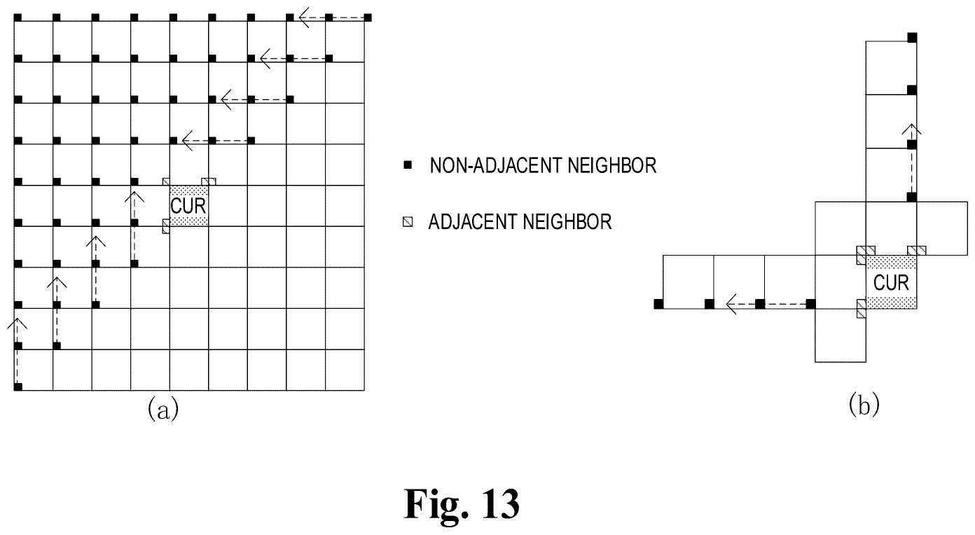

FIG. 13 illustrates spatial neighbors for deriving affine merge/AMVP candidates: (a) for deriving inherited candidates (b) for deriving the first type of constructed candidates.

In NA-AFF, the pattern of obtaining non-adjacent spatial neighbors is shown in FIG. 13. Same as the existing non-adjacent regular merge candidates, the distances between non-adjacent spatial neighbors and current coding block in the NA-AFF are also defined based on the width and height of current CU.

The motion information of the non-adjacent spatial neighbors in FIG. 13 is utilized to generate additional inherited and constructed affine merge/AMVP candidates. Specifically, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. As indicated by the red dash arrows in (a) of FIG. 13, the checking orders of the neighbors on the left and above sides are bottom-to-up and right-to-left, respectively.

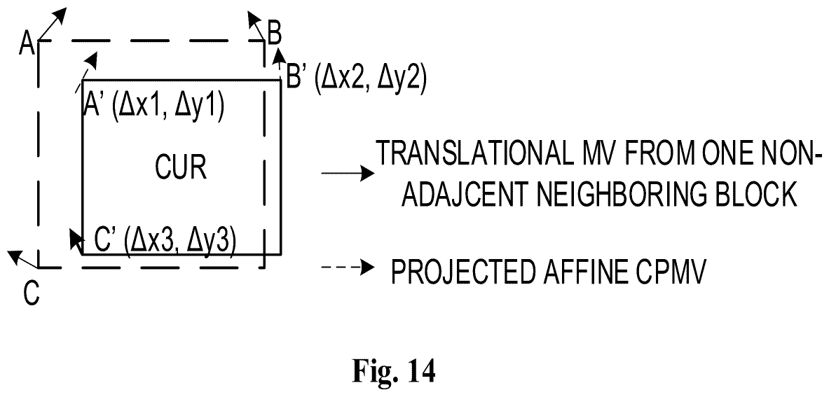

For the first type of constructed candidates, as shown in the (b) of FIG. 13, the positions of one left and above non-adjacent spatial neighbors are firstly determined independently; After that, the location of the top-left neighbor can be determined accordingly which can enclose a rectangular virtual block together with the left and above non-adjacent neighbors. Then, as shown in the FIG. 14 which illustrates an example diagram from non-adjacent neighbors to the first type of constructed affine merge/AMVP candidates, the motion information of the three non-adjacent neighbors is used to form the CPMVs at the top-left (A), top-right (B) and bottom-left (C) of the virtual block, which is finally projected to the current CU to generate the corresponding constructed candidates.

The NA-AFF candidates are inserted into the existing affine merge candidate list and affine AMVP candidate list according to the following orders:

### Affine Merge Mode

1. SbTMVP candidate, if available,
2. Inherited from adjacent neighbors,
3. Inherited from non-adjacent neighbors,
4. Constructed from adjacent neighbors,
5. The first type of constructed affine candidates from non-adjacent neighbors,
6. Zero MVs.

### Affine AMVP Mode

1. Inherited from adjacent neighbors,
2. Constructed from adjacent neighbors,
3. Translational MVs from adjacent neighbors,
4. Translational MVs from temporal neighbors,
5. Inherited from non-adjacent neighbors,
6. The first type of constructed affine candidates from non-adjacent neighbors,
7. Zero MVs

Due to the inclusion of the additional candidates generated by NA-AFF, the size of the affine merge candidate list is increased from 5 to 15. The subgroup size of ARMC for the affine merge mode is increased from 3 to 15.

In NA-AFF:
1. The area from where the non-adjacent neighbors come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### 2.4. Regression Based Affine Candidate Derivation

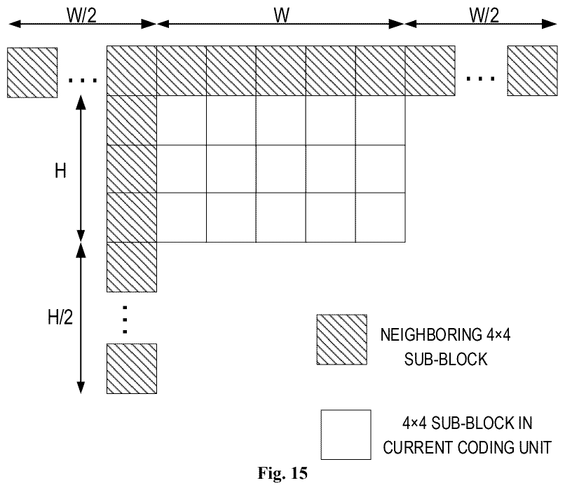

During the VVC standardization progress, the Regression based Motion Vector Field (RMVF) derivation method was proposed which provides a new variety of subblock-based merge candidate. FIG. 15 illustrates illustration of the neighboring 4×4 subblocks that are used for RMVF parameter derivation. W and H are the width and height of the current CU. The motion vectors and center positions from the neighboring subblocks of the current CU, as illustrated in FIG. 15, are used as the input to the linear regression process to derive a set of linear model parameters.

Regression based affine candidate derivation method was proposed. the subblock motion field from a previous coded affine CU and the motion vectors from the adjacent subblocks of current CU are used as the input for the regression process. Compares to the regression process, the difference is that the predicted CPMVs instead of the subblock motion field for current block are derived as output. It was decided to test the proposed method in EE2.

This contribution reports the EE test results of the proposed method on top of ECM-5.0. A total of 3 tests have been performed.

In test a, the regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table.

Adjacent subblock information of current CU is fetched from 4×4 sub-blocks represented by the grey zone as depicted in FIG. 15. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

In test b, the number of affine candidates for ARMC is increased from 15 to 30, the output list size is kept as 15.

Finally in test c, the diversity criterion for ARMC sorting tested in EE2-2.5 are applied on top of test b.

### 2.5. Planar Motion Vector Prediction

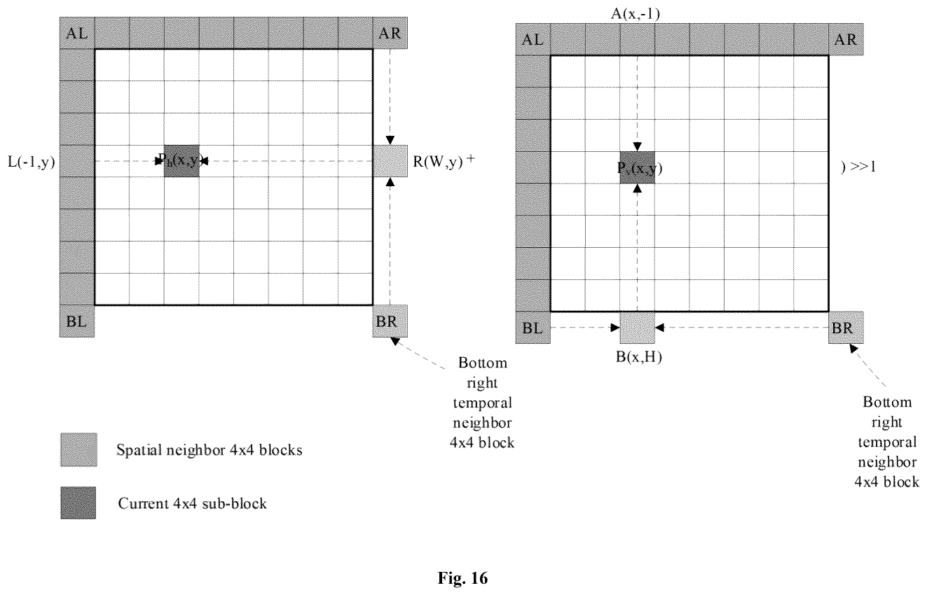

To generate a smooth fine granularity motion field, FIG. 16 gives a brief description of the planar motion vector prediction process.

Planar motion vector prediction is achieved by averaging a horizontal and vertical linear interpolation on 4×4 block basis as follows.

$$P ( x , y ) = ( H \times {P}_{h} ( x , y ) + W \times {P}_{v} ( x , y ) + H \times W ) / ( 2 \times H \times W )$$

W and H denote the width and the height of the block. (x,y) is the coordinates of current sub-block relative to the above left corner sub-block. All the distances are denoted by the pixel distances divided by 4.P(x, y) is the motion vector of current sub-block.

The horizontal prediction Pₕ(x, y) and the vertical prediction Pᵥ(x, y) for location (x,y) are calculated as follows:

$${P}_{h} ( x , y ) = ( W - 1 - x ) \times L ( - 1 , y ) + ( x + 1 ) \times R ( W , y )$$

$${P}_{v} ( x , y ) = ( H - 1 - y ) \times A ( x , - 1 ) + ( y + 1 ) \times B ( x , H )$$

where L(−1, y) and R(W, y) are the motion vectors of the 4×4 blocks to the left and right of the current block. A(x, −1) and B(x, H) are the motion vectors of the 4×4 blocks to the above and bottom of the current block.

The reference motion information of the left column and above row neighbour blocks are derived from the spatial neighbour blocks of current block.

The reference motion information of the right column and bottom row neighbour blocks are derived as follows.
1) Derive the motion information of the bottom right temporal neighbour 4×4 block.
2) Compute the motion vectors of the right column neighbour 4×4 blocks, using the derived motion information of the bottom right neighbour 4×4 block along with the motion information of the above right neighbour 4×4 block, as described in Equation (2-10).
3) Compute the motion vectors of the bottom row neighbour 4×4 blocks, using the derived motion information of the bottom right neighbour 4×4 block along with the motion information of the bottom left neighbour 4×4 block, as described in Equation (2-11).

$$R ( W , y ) = ( ( H - y - 1 ) \times AR + ( y + 1 ) \times BR ) / H \qquad ( 2 - 10 )$$

$$B ( x , H ) = ( ( W - x - 1 ) \times BL + ( x + 1 ) \times BR ) / W \qquad ( 2 - 11 )$$

where AR is the motion vector of the above right spatial neighbour 4×4 block, BR is the motion vector of the bottom right temporal neighbour 4×4 block, and BL is the motion vector of the bottom left spatial neighbour 4×4 block.

The motion information obtained from the neighbouring blocks for each list is scaled to the first reference picture for a given list.

### 2.6. Bilinear Interpolation Model

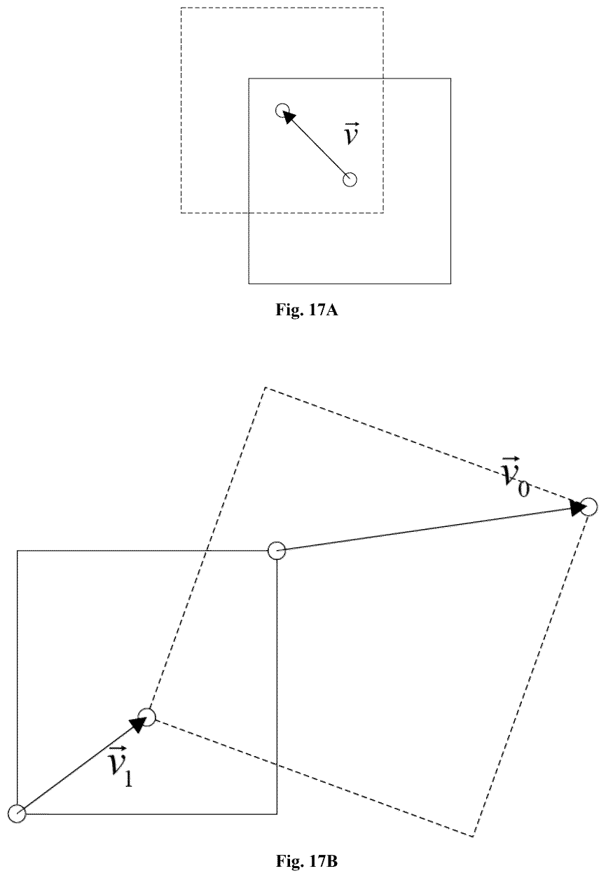

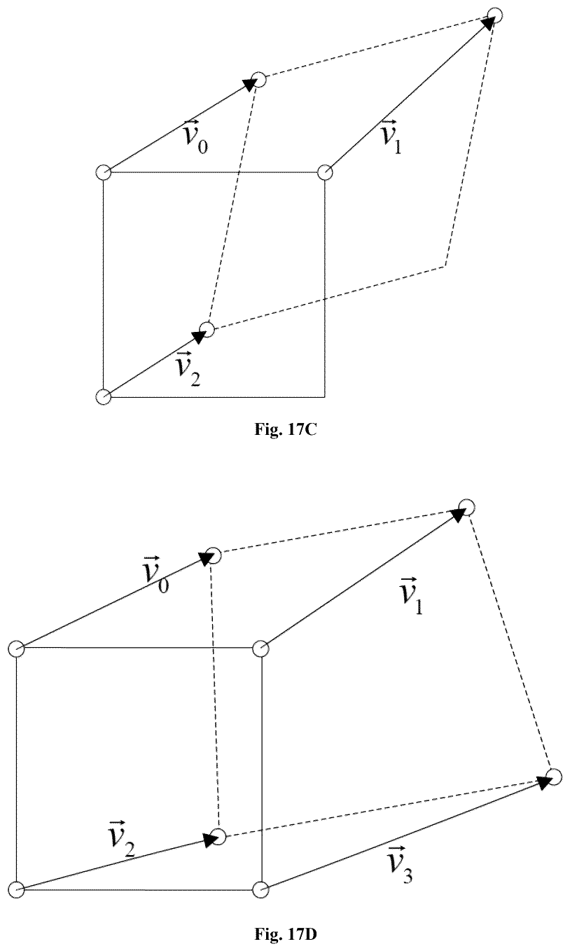

The core idea of bilinear interpolation is performing a linear interpolation in two directions respectively. FIG. 17A to FIG. 17D illustrate examples of translational and non-translational motion, where FIG. 17A illustrates a translational motion which can be represented by BMME, FIG. 17B illustrates a zoom and rotation which can be represented by four-parameter affine model with two control points, FIG. 17C illustrates a regular deformation motion which can be represented by six-parameter affine model with three control points, and FIG. 17D illustrates a irregular deformation motion which can be represented by bilinear interpolation model with four control points. An example of irregular deformation motion which can be represented by bilinear interpolation model is shown in FIG. 17D, where the motion information of each pixel in a block can be computed from the motion information of its four control points according to the bilinear interpolation model.

### 2.6.1. Derivation of Motion Information for Control Points

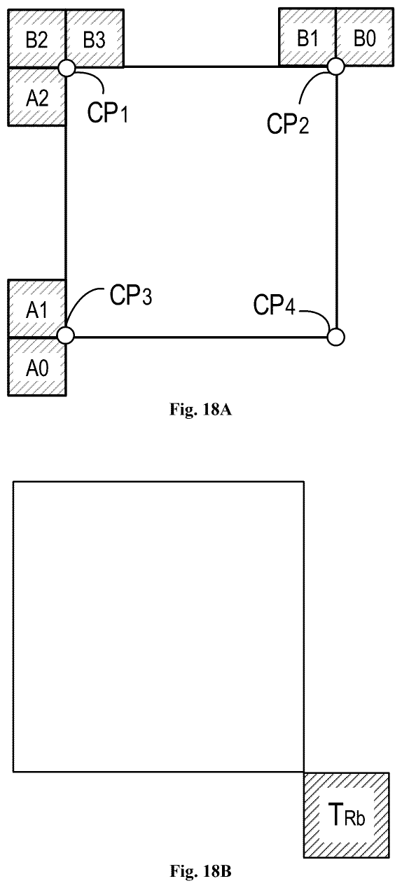

FIG. 18A illustrates candidate positions for predicting the motion information of each control point of a block for spatial neighbors. FIG. 18B illustrates candidate positions for predicting the motion information of each control point of a block for temporal neighbor.

Candidate positions for predicting the motion information of each control point of a block are shown in FIG. 18A and FIG. 18B. In FIG. 18A and FIG. 18B, CPₖ (k=1,2,3,4) represents the k-th control point. The spatial candidate positions for predicting the motion information of CPₖ (k=1,2,3) are shown in FIG. 18A. The temporal candidate position for predicting the motion information of CP₄ is shown in FIG. 18B.

The motion information of each control point is obtained according to the following priority order:
For CP₁, the checking priority is B₂->A₂->B₃, B₂ is used if it is available. Otherwise, if A₂ is available, A₂ is used. If both A₂ and B₂ are unavailable, B₃ is used. If all the three candidates are unavailable, the motion information of CP₁ cannot be obtained.
For CP₂, the checking priority is B₀->B₁.
For CP₃, the checking priority is A₀->A₁.
For CP₄, T_{Rb} is used.

Only when the motion information of all the four control points can be derived and they are not identical in at least one reference list, can the motion information of each sub-block in the current block be interpolated.

### 2.6.2. Derivation of Motion Vector for Sub-Block

After deriving the MVs of control points, they are used to interpolate the MV of each sub-block in the current block as following.

$$\text{?} = {\sum }_{k = 1}^{4} {ϕ}_{k} \text{?}$$

$$\text{?} \text{indicates text missing or illegible when filed}$$

$${{\to }_{MV}}_{{CP}_{k}}$$

denotes the MV of the k-th control point and

$${\to }_{MV}$$

denotes the MV of the current sub-block.

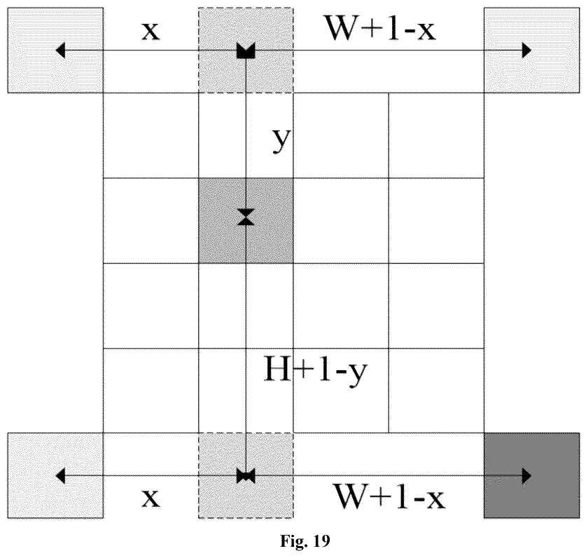

The interpolation kernel ||ₖ depends on the contribution of CPₖ to current sub-block. The interpolation function is bilinear interpolation function. Equation (2-12) gives the interpolation kernels corresponding to FIG. 19.

$${ϕ}_{1} = ( ( W + 1 - x ) \cdot ( H + 1 - y ) ) / ( ( W + 1 ) \cdot ( H + 1 ) ) \qquad ( 2 - 12 )$$

$${ϕ}_{2} = ( x \cdot ( H + 1 - y ) ) / ( ( W + 1 ) \cdot ( H + 1 ) )$$

$${ϕ}_{3} = ( ( W + 1 - x ) \cdot y ) / ( ( W + 1 ) \cdot ( H + 1 ) )$$

$${ϕ}_{4} = ( x \cdot y ) / ( ( W + 1 ) \cdot ( H + 1 ) ) .$$

FIG. 19 illustrates sketch map of bilinear interpolation model for a 16×16 block. In Equation (2-12) and FIG. 19, W and H denote the width and the height of the block. (x, y) is the coordinates of current sub-block. All the distances are denoted by the pixel distances divided by 4.

### 2.6.3. Derivation of Reference Index for Sub-Block

The reference index is used to indicate the reference picture. After determining the motion information of each control point, the reference index for each sub-block is derived as follows.

If all of the four control points have the same reference index, this reference index is selected as the reference index of each sub-block. Otherwise, the reference index with the highest utilization rate among the reference indices of the four control points is selected. Notice the possibility that there may be more than one reference indices with the highest utilization rate. In this situation, the one with the smallest index is selected as the reference index of each sub-block. This is because the reference picture with the smallest reference index has the shortest temporal distance with the current picture.

### 2.6.4. Scaling Motion Vector of Control Point

Before using the MVs of control points to interpolate MV of a sub-block, they should be preprocessed. If the MV of a control point pointing to a different reference picture from the reference picture of the sub-block, the MV is scaled. The scaling process is performed according to the picture order count (POC) distances similar to derivation process for temporal merge candidate.

### 2.7. Planar Horizontal Mode and Planar Vertical Mode

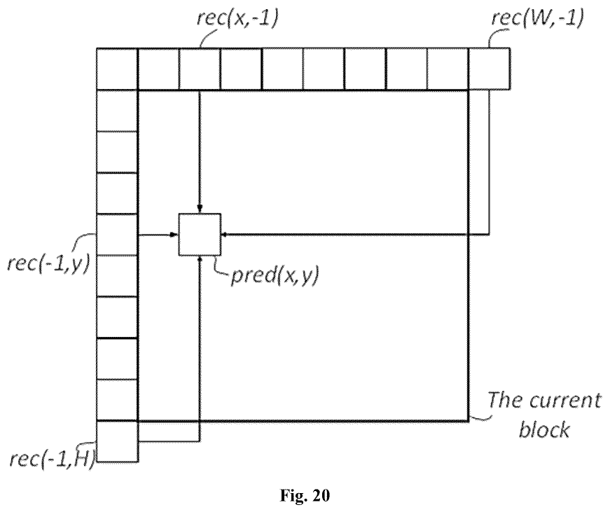

In the planar mode, the predicted value of the current sample is obtained from the reconstructed values of 4 reference samples as shown in FIG. 20 which illustrates the reference samples used in planar mode. Specifically, linear interpolation in the horizontal direction and vertical direction are performed respectively, and the two results are averaged to obtain the predicted sample as shown in the following equations.

$$predV ( x , y ) = ( ( H - 1 - y ) * rec ( x , - 1 ) + ( y + 1 ) * rec ( - 1 , H ) ) ≪ {log}_{2} W$$

$$predH ( x , y ) = ( ( W - 1 - x ) * rec ( - 1 , y ) + ( x + 1 ) * rec ( W , - 1 ) ) ≪ {log}_{2} H$$

$$pred ( x , y ) = ( predV ( x , y ) + predH ( x , y ) + W * H ) ≫ ( {log}_{2} W + {log}_{2} H + 1 ) .$$

This contribution proposes two additional planar mode: planar horizontal mode and planar vertical mode. For planar horizontal mode, only the horizontal linear interpolation is performed based on the left reference sample and the ton-right reference sample to predict the current sample as:

$$pred ( x , y ) = ( ( W - 1 - x ) * rec ( - 1 , y ) + ( x + 1 ) * rec ( W , - 1 ) + ( W ≫ 1 ) ) ≫ {log}_{2} W$$

For planar vertical mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H ≫ 1 ) ) ≫ {log}_{2} H$$

The proposed two additional planar modes are only applied to the luma component and is not used for ISP coded blocks. When the current block enables one of the two proposed planar modes, the block's propagation mode is set to the original planar mode.

For signaling, if the planar flag indicates that a planar mode is used for the current block and the current block is a non-ISP coded luma block, a syntax element is further signaled by truncated unary code to indicate which of the original planar mode, the planar horizontal mode and the planar vertical mode is selected to predict the current block.

### 2.8. Enhanced Temporal Motion Information Derivation

In ECM, the temporal MVP for AMVP mode is derived by fetching the motion information from center or bottom-right location in the collocated frame. And a similar strategy is also applied to sbTMVP mode, where the motion information from the left neighbouring position is used as a motion shift, which is then employed to obtain a MVP at sub-CU level for the to-be-coded CU. It is asserted that such a design may not ensure the trajectory consistency between the pre-defined positions and current CU.

In this proposal, two aspects are proposed to further improve TMVP in sbTMVP and AMVP modes. Firstly, two collocated frames are utilized to provide temporal motion information. Secondly, the motion shift to locate TMVP is adaptively determined from multiple locations according to template costs.

When constructing sub-block-based merge candidate list and AMVP candidate list, two reference frames with the least POC distance relative to the to-be-coded frame are determined to be the collocated frames.

For the two collocated frames, two motion shift candidate lists are constructed respectively. When constructing the motion shift list Li for the i-th collocated frame Ci, the motion information of existing candidates in the motion candidate list are checked. If either MV of the motion candidate points to Ci, the corresponding MV is included into Li serving as a motion shift candidate. The motion shift with the minimum template matching cost is used to derive sbTMVP or TMVP candidate.

ARMC [5] for the sub-block-based merge candidate list is modified accordingly since one more sbTMVP candidate is included. In the proposed method, the sbTMVP candidate that are derived from the first collocated frame is placed in the first entry without reordering. While the other sbTMVP candidate is sorted together with AFFINE candidates.

### 2.9. Extended Merge Prediction

In VVC, the merge candidate list is constructed by including the following five types of candidates in order:
1) Spatial MVP from spatial neighbour CUs,
2) Temporal MVP from collocated CUs,
3) History-based MVP from an FIFO table,
4) Pairwise average MVP,
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.9.1 Spatial Candidates Derivation

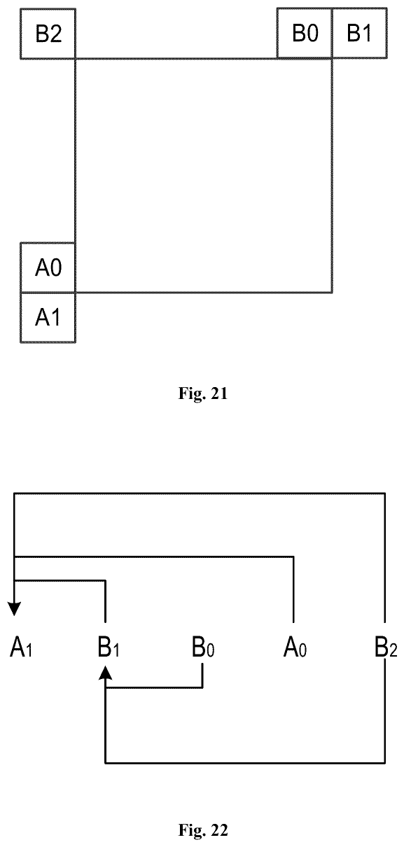

The derivation of spatial merge candidates in VVC is same to that in HEVC except the positions of first two merge candidates are swapped. A maximum of four merge candidates are selected among candidates located in the positions depicted in FIG. 21 which illustrates positions of spatial merge candidate. The order of derivation is B₁, A₁ B₀, A₀, and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 22 illustrates candidate pairs considered for redundancy check of spatial merge candidates. Instead only the pairs linked with an arrow in FIG. 22 are considered and a candidate is only added to the list if the corresponding candidate used for redundancy check has not the same motion information.

### 2.9.2 Temporal Candidates Derivation

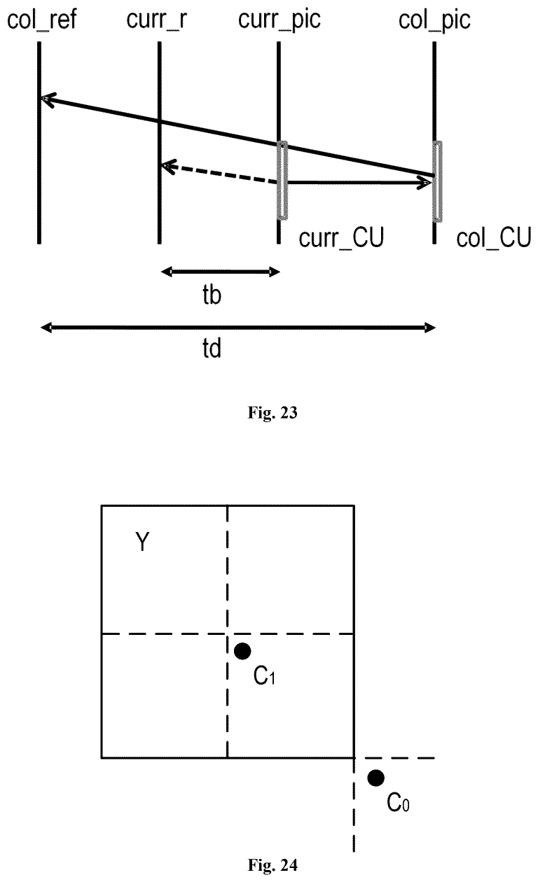

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 23 which illustrates motion vector scaling for temporal merge candidate, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 24. If CU at position C₀ is not available, is intra coded, or is outside of the current row of CTUs, position C₁ is used. Otherwise, position C₀ is used in the derivation of the temporal merge candidate.

### 2.9.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### 2.9.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.10. New Merge Candidates

### 2.10.1 Non-Adjacent Merge Candidates Derivation

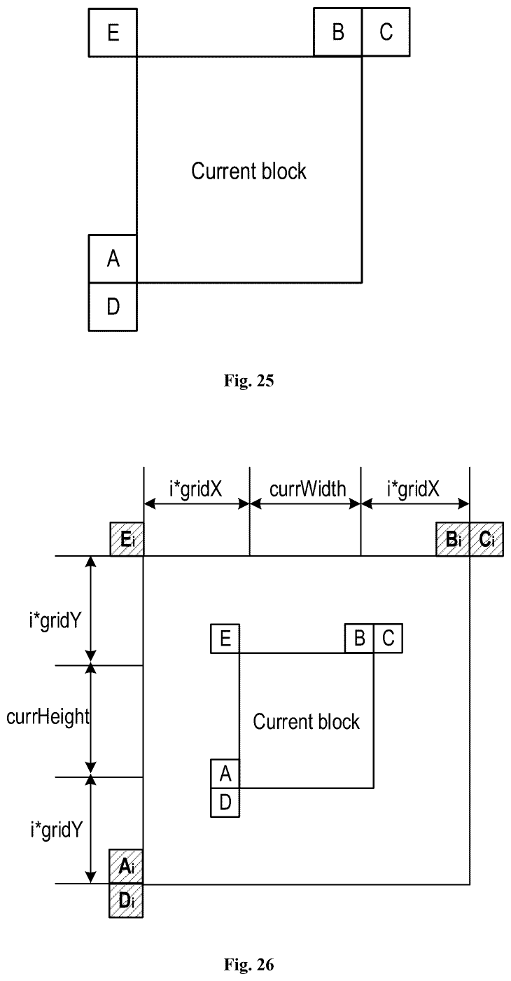

In VVC, five spatially neighboring blocks shown in FIG. 25 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:
Offset =−i×gridX, Offsety=−i×gridY where the Offsetx and Offsety denote the offset of the top-left corner of the virtual block relative to the top-left corner of the current block, gridX and gridY are the width and height of the search grid.

Second, the width and height of the virtual block are calculated by:
newWidth=i×2×gridX+currWidth newHeight=i×2×gridY+currHeight. where the currWidth and currHeight are the width and height of current block. The newWidth and newHeight are the width and height of new virtual block. gridX and gridY are currently set to currWidth and currHeight, respectively.

FIG. 26 illustrates the relationship between the virtual block and the current block. FIG. 26 illustrates an illustration of virtual block in the i-th search round.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.10.2 Non-adjacent Spatial Candidate

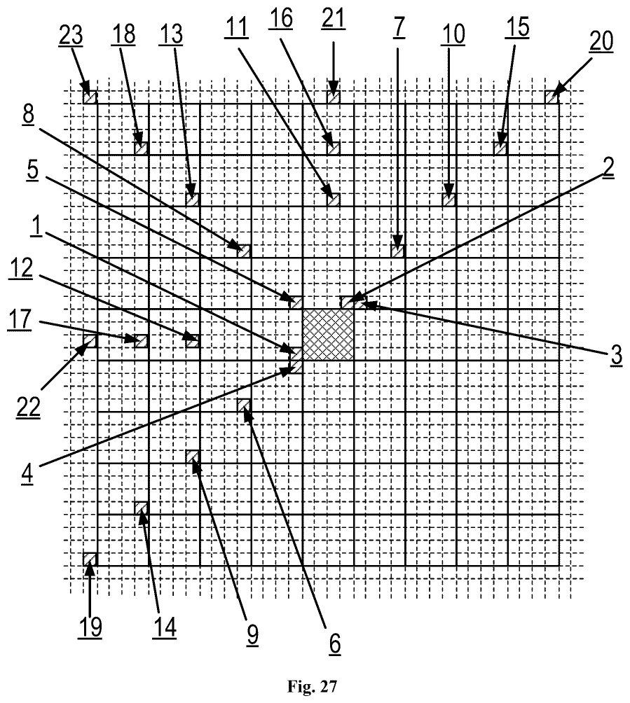

The non-adjacent spatial merge candidates are inserted after the TMVP in the regular merge candidate list. The pattern of spatial merge candidates is shown in FIG. 27. FIG. 27 illustrates spatial neighboring blocks used to derive the spatial merge candidates. The distances between non-adjacent spatial candidates and current coding block are based on the width and height of current coding block. The line buffer restriction is not applied.

### 2.10.3 Non-Adjacent Temporal Candidate

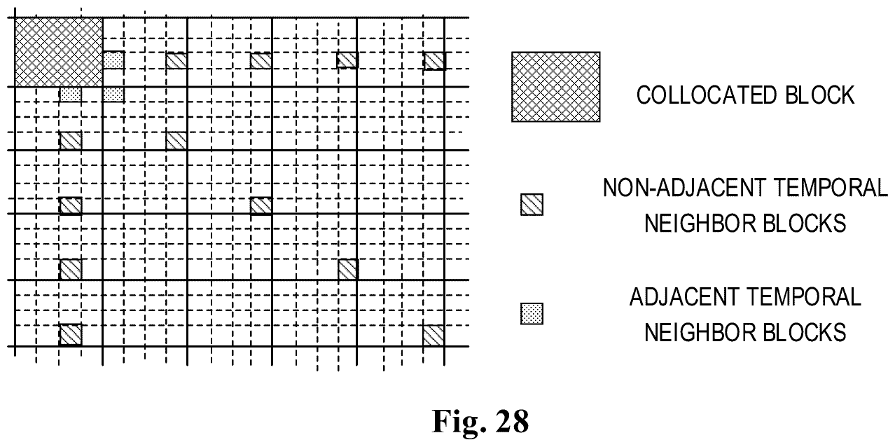

FIG. 28 illustrates non-adjacent temporal neighboring blocks used to derive the non-adjacent temporal merge candidates. The non-adjacent temporal positions are introduced as shown in FIG. 28, where non-adjacent temporal MVP positions locate in the same reference frame as the adjacent TMVP. The distances between non-adjacent temporal candidates and current coding block are based on the width and height of current coding block.

### 2.11. Adaptive Decoder Side Motion Vector Refinement

Adaptive decoder side motion vector refinement method consists of the two new merge modes introduced to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1^{st} pass (i.e. PU level) DMVR. Like the regular merge mode, merge candidates for the proposed merge modes are derived from the spatial neighboring coded blocks, TMVPs, non-adjacent blocks, HMVPs, and pair-wise candidate. The difference is that only those meet DMVR conditions are added into the candidate list. The same merge candidate list is used by the two proposed merge modes and merge index is coded as in regular merge mode.

### 2.12. DMVR for Affine Merge Coded Blocks (Affine DMVR)

Generally, affine model can be described using the following equations

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 - 13 )$$

wherein (mvₓ, mv_{y}) is the motion vector at location (x, y), (mv₀ₓ, mv_{0y}) is the base MV representing the translation motion of the affine model, and

$$\frac{{mv}_{1 x} - {mv}_{0 x}}{W} , \frac{{mv}_{2 x} - {mv}_{0 x}}{H} , \frac{{mv}_{1 y} - {mv}_{0 y}}{W} and \frac{{mv}_{2 y} - {mv}_{0 y}}{H}$$

are four non-translation parameters which defines rotation, scaling and other non-translation motion of the affine model. In ECM, besides 6-parameters affine model defined as (2-13), there are also 4-parameters affine mode described as (2-14) in which only two non-translation parameters are used.

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} . \qquad ( 2 - 14 )$$

The base MV of the affine model of the coding blocks coded with the affine merge mode is refined by only applying first step of multi-pass DMVR. That is, a translation MV offset is added to all the CPMVs of the candidate in the affine merge list if the candidate meets the DMVR condition. And the MV offset is derived by minimizing the cost of bilateral matching which is the same as conventional DMVR. And the DMVR condition is also not changed.

The MV offset searching process is similar as the first pass of multi-pass DMVR in ECM. 3×3 square search pattern is used to loop through the search range which is set as [−3, 3] to find the best integer MV offset. And then half-pel search is conducted around the best integer position and an error surface estimation is performed at last to find a optimal MV offset with 1/16 precision. For simplicity, 2-tap bilinear interpolation is used instead of 12-tap DCT-IF during the search process, which is also the same as what multi-pass DMVR does.

### 2.13. Decoder-Side Affine Model Refinement (DAMR) for Affine DMVR

A decoder-side affine model refinement (DAMR) is proposed in which both the base MV and the non-translation parameters of the affine mode are refined.

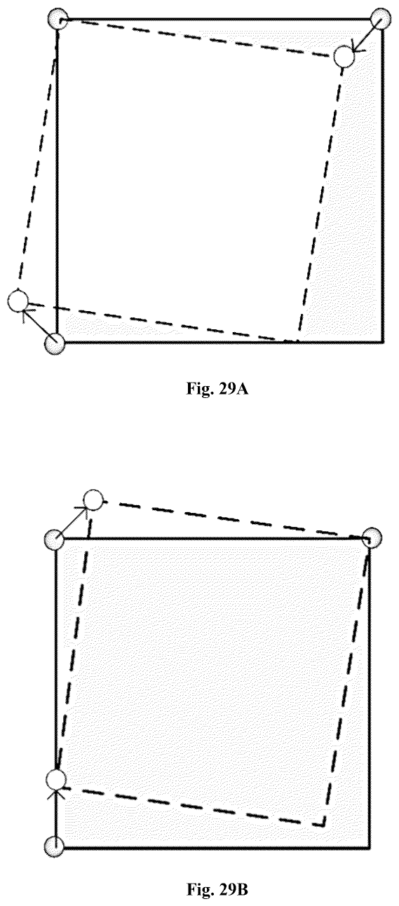

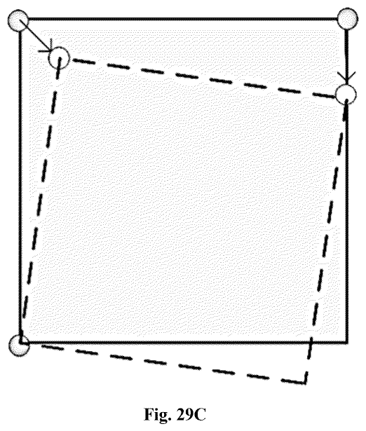

It is proposed to refine all the parameters of the affine model to improve the accuracy of the model inherited from the neighboring blocks. The refinement is divided into two steps. In the first step, only the base MV is refined and the non-translation parameters are kept. The first step is the same as that of 2.12 section. FIG. 29A to FIG. 29C illustrate three stages of non-translation parameters search, respectively.

In the second step, based on the affine model refined in the first step, the non-translation parameters are refined. The search process has three stages. In the first stage as shown in FIG. 29A, the top-left CPMV is fixed as base MV of the affine model and the parameters a, b, c and d are jointly searched with a cross pattern to find best values by minimizing the cost of bilateral matching. Then CPMVs are recalculated with the refined parameter values of a, b, c and d. In the second stage as shown in FIG. 29B, the new top-right CPMV is fixed as the base MV and the parameters a, b, c and d are jointly searched again to find new best values, and CPMVs are recalculated again after search. In the third stage as shown in FIG. 29C, the new left-bottom CPMV is fixed as the base MV and the same search process is applied on parameters a, b, c and d once again to get the final refined model. For 4-parameter affine model, only parameters a and b need to be refined and the search process itself is the same as that for 6-parameter affine model. For each search point in the search process, motion compensation is applied for the whole CU and the SAD between two predictors of the CU are used as the cost.

### 2.14. Sub-Block Processing for Affine DMVR

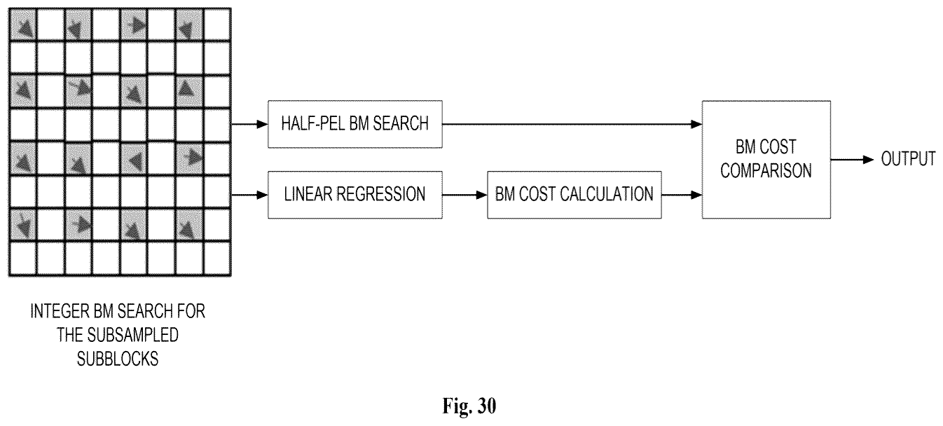

FIG. 30 illustrates sub-block processing for affine DMVR. The proposed method can be illustrated in FIG. 30, and summarized as the following:
1) Perform integer bilateral matching is for a subset of subblocks. Accumulate the subblock bilateral matching cost to determine the best integer MV offset.
2) Perform half-pel bilateral matching search using the best integer MV offset as initial offset and output a best MV offset that minimizes the bilateral matching cost for the same subset of subblocks in step 1.
3) Perform linear regression using the refined subblock MVs from step 1 as input and output a set of control-point motion vectors.
4) Compare the bilateral matching cost of the output of the steps 2 and 3 to select the one with the smallest cost.

Note that steps 1 and 2 are similar to that of 2.12 section. The major difference is that only a subset of subblocks is used for bilateral matching cost calculation.

### 2.15. Control-Point Motion Vector Refinement for Affine DMVR

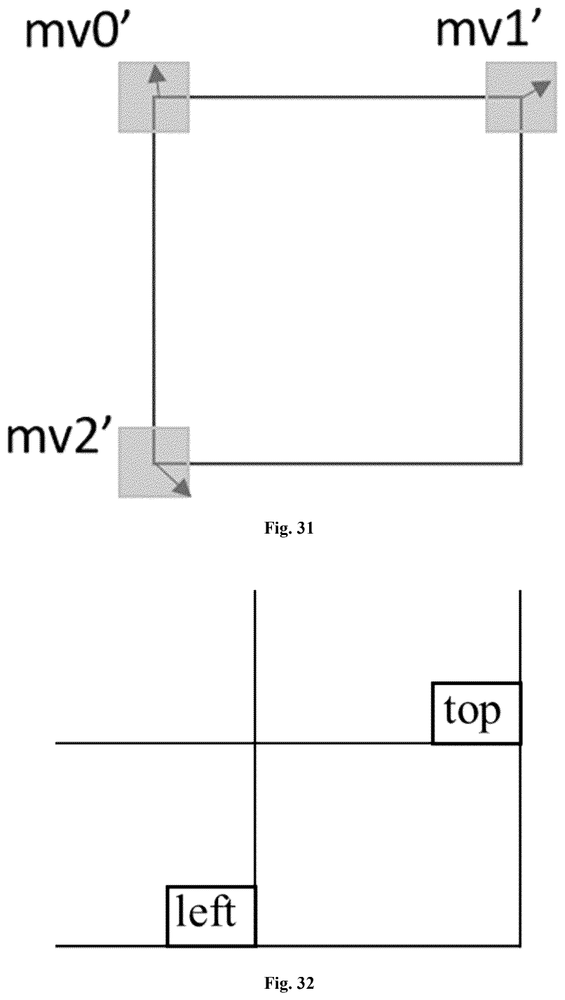

Given initial control-point motion vectors (CPMV) initCpMvLX[cpIdx] with cpIdx=0. . numCpMv−1, wherein the numCpMv is the number of CPMVs of the current affine coding block. The proposed method can be described in the following steps:
1) For each control-point, perform bilateral matching for a block that centered by the control-points to derive the refined CPMVs bmRefinedCpMvLx[cpIdx], as illustrated in FIG. 31. FIG. 31 illustrates illustration of independent bilateral matching search for CPMVs.
2) Loop over combinations of initCpMvLX[cpIdx] and bmRefinedCpMvLx[cpIdx], derive a best set of CPMVs that minimize the bilateral matching cost of the current block.
3) Iteratively further refine the CPMVs to minimize the bilateral matching cost of the current block. In each iteration, one CPMV is refined while the others are fixed.

### 2.16. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 32) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2.$$

### 2.17. Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, a*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.18. Decoder Side Motion Vector Refinement (DMVR)

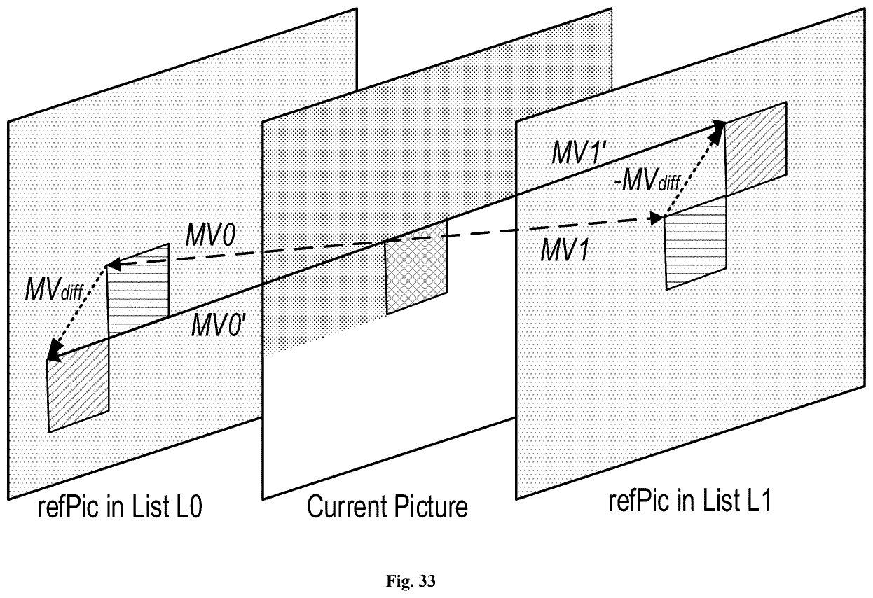

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 33 illustrates decoding side motion vector refinement. As illustrated in FIG. 33, the SAD between the red blocks based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV,
One reference picture is in the past and another reference picture is in the future with respect to the current picture,
The distances (i.e. POC difference) from two reference pictures to the current picture are same,
Both reference pictures are short-term reference pictures,
CU has more than 64 luma samples,
Both CU height and CU width are larger than or equal to 8 luma samples,
BCW weight index indicates equal weight,
WP is not enabled for the current block,
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.18.1 Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset ,$$

$$MV {1}^{′} = MV 1 - MV\_offset .$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by 1/4 of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied. In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$$\begin{matrix}{x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) , \\ {y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) .\end{matrix}$$

The value of xₘᵢₙ and yₘᵢₙ are automatically constrained to be between −8 and 8 since all cost values are positive and the smallest value is E (0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.18.2 Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.18.3 Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.19. Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.19.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW * cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range. The existing fractional sample refinement is further applied to derive the final deltaMV. The refined MVs after the first pass is then derived as:

$$\begin{matrix}MV 0 \_pass1 = MV 0 + deltaMV , \\ MV 1 \_pass 1 = MV 1 - deltaMV .\end{matrix}$$

### 2.19.2 Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbId×2) and MV1_pass2(sbId×2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

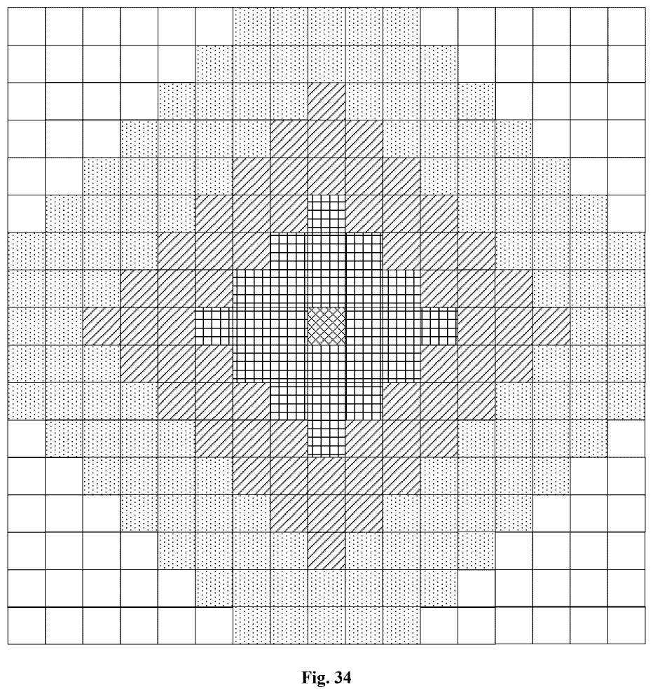

The bilateral matching cost is calculated by applying a cost factor to the SATD cost between two reference subblocks, as: bilCost=satdCost * costFactor. The search area (2*sHor+1) * (2*sVer+1) is divided up to 5 diamond shape search regions shown on FIG. 34 which illustrates diamond regions in the search area. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW * sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbId×2).

The refined MVs at second pass is then derived as:

$$\begin{matrix}MV 0 \_pass2 ( sbIdx 2 ) = MV 0 \_pass1 + deltaMV ( sbIdx 2 ) , \\ MV 1 \_pass2 ( sbIdx 2 ) = MV 1 \_pass1 + deltaMV ( sbIdx 2 ) .\end{matrix}$$

### 2.19.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs(MV0_pass3(sbId×3) and MV1_pass3(sbId×3)) at third pass are derived as:

$$\begin{matrix}MV 0 \_pass3 ( sbIdx 3 ) = MV 0 \_pass2 ( sbIdx 2 ) + bioMv , \\ MV 1 \_pass3 ( sbIdx 3 ) = MV 0 \_pass2 ( sbIdx 2 ) - bioMv .\end{matrix}$$

### 2.20. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process. First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\begin{matrix}\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )\end{matrix}$$

where I^{(k)}(i, j) are the sample value at coordinate (i, j) of the prediction signal in list k, k=0,1, and shift1 is calculated based on the luma bit depth, bitDepth, as shift1=max (6, bitDepth-6).

Then, the auto-and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{x} ( i , j ) ) , {S}_{6} = {\sum }_{( i , j ) ∈ Ω} θ ( i , j ) \cdot Sign ( {ψ}_{x} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth-11) and min (4, bitDepth-8), respectively.

The motion refinement (vₓ, v_{y}) is then derived using the cross-and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where S_{2,m}=S₂>>nₛ₂, S_{2,s}=S₂& (2ⁿ^{ₛ₂}−1), th′_{BIO}=2^{max(5,BD-7)}. [.] is the floor function, and nₛ_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial x} - \frac{\partial {I}^{( 0 )} ( x , y )}{\partial x} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift .$$

These values are selected such that the multipliers in the BDOF process do not exceed 15-bit, and the maximum bit-width of the intermediate parameters in the BDOF process is kept within 32-bit.

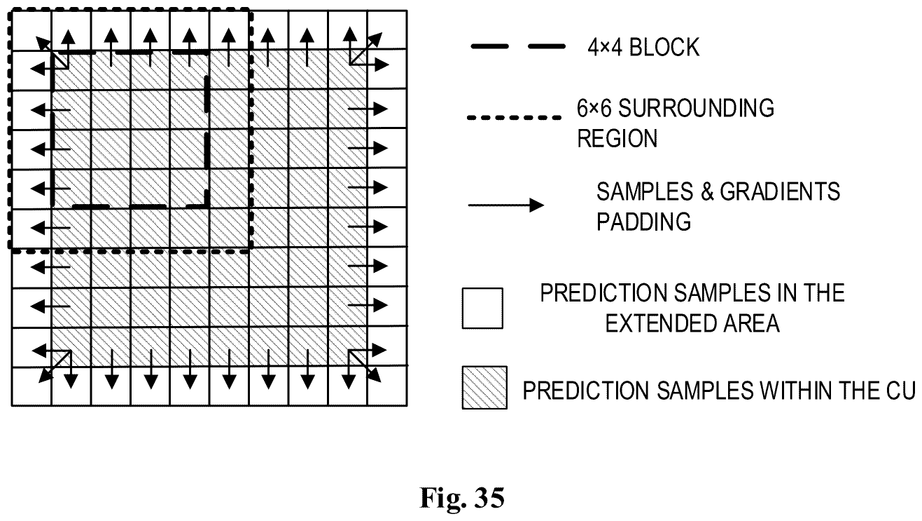

In order to derive the gradient values, some prediction samples I^{(k)}(i, j) in list k (k=0,1) outside of the current CU boundaries need to be generated. FIG. 35 illustrates an extended CU region used in BDOF. As depicted in FIG. 35, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8 * W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 3. Problems

For affine DMVR, it refines affine information (e.g., base MV and/or the non-translation parameters and/or CPMVs) in two prediction directions. However, for certain cases, there is no need to refine the affine information for both directions even for the affine bi-prediction merge candidates that meet the DMVR conditions. For example, affine DMVR should only refine base MV and/or the non-translation parameters and/or CPMV only in one prediction direction, either reference list 0 (LO) or reference list 1 (L1).

The inter prediction signal in the CIIP mode Pinter can be further improved by enabling one or some inter coding tools.

### 4. Detailed Solutions

The detailed embodiments below should be considered as examples to explain general concepts. These embodiments should not be interpreted in a narrow way. Furthermore, these embodiments can be combined in any manner.

In one example, affine information may represent base MVs and/or the non-translation parameters and/or CPMVs and/or MVDs and/or other parameters that are utilized during the decoding process of an affine-coded block.

In one example, the 6-parameters affine model can be described using the following equations:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

wherein (mvₓ, mv_{y}) is the motion vector at location (x, y), (mv₀ₓ, mv_{0y}) is the base MV representing the translation motion of the affine model, and

$$\frac{{mv}_{1 x} - {mv}_{0 x}}{W} , \frac{{mv}_{2 x} - {mv}_{0 x}}{H} , \frac{{mv}_{1 y} - {mv}_{0 y}}{W} and \frac{{mv}_{2 y} - {mv}_{0 y}}{H}$$

are four non-translation parameters which defines rotation, scaling and other non-translation motion of the affine model.

In one example, the 4-parameters affine model can be described using the following equations:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

wherein (mvₓ, mv_{y}) is the motion vector at location (x, y), (mv₀ₓ, mv_{0y}) is the base MV representing the translation motion of the affine model, and

$$\frac{{mv}_{1 x} - {mv}_{0 x}}{W} and \frac{{mv}_{1 y} - {mv}_{0 y}}{W}$$

are two non-translation parameters.

In one example, for both 4-parameters affine model (as shown in FIG. 4A) and 6-parameters affine model (as shown in FIG. 4B), (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

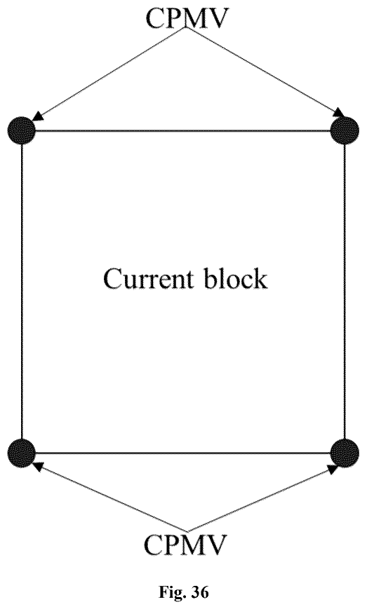

CPMV is control point motion vector, which can be located, in one example, in top-left corner, top-right corner, bottom-left corner, and bottom-right corner of current block as shown in FIG. 36, which illustrates a control point motion vector.

It should be noted that the term ‘adaptive affine DMVR’ is not restricted to the one introduced in aforementioned sections. Any variance of affine information refinement is also applicable.

### Adaptive Affine Decoder Side Motion Vector Refinement (DMVR)

1. It is proposed to refine affine information for only one prediction direction/one reference picture list even for bi-prediction coded blocks with affine motion.
2. It is proposed to refine affine information for only one prediction direction/one reference picture list even for multiple-hypothesis coded blocks with affine motion.
3. It is proposed to refine affine information for uni-prediction coded blocks with affine motion.
   a. In one example, template matching may be applied during the refinement process.
4. Adaptive affine DMVR may perform bilateral matching refinement only in one prediction direction for the affine bi-prediction merge candidates.
   a. In one example, adaptive affine DMVR may perform bilateral matching refinement only in reference list 0 (L0).
   b. In one example, adaptive affine DMVR may perform bilateral matching refinement only in reference list 1 (L1).
   c. In one example, the bilateral matching refinement may be for base MV and/or the non-translation parameters and/or CPMV.
   d. In one example, if the bilateral matching refinement is for base MV, either its motion vector difference of reference list 0 (MVD0) or motion vector difference of reference list 1 (MVD1) may be set to zero.
   e. In one example, if the bilateral matching refinement is for CPMV, either its motion vector difference of reference list 0 (MVD0) or motion vector difference of reference list 1 (MVD1) may be set to zero.
   f. In one example, if the bilateral matching refinement is for the non-translation parameters, either non-translation parameters of reference list 0 (NTP0) or non-translation parameters of reference list 1 (NTP1) may be kept unchanged.
   g. In one example, the MVD searching process may be similar as the first pass of adaptive DMVR.
      (a) In one example, M×M square search pattern may be used to loop through the search range which is set as [−M, M] to find the best integer MVD. And then half-pel search may be conducted around the best integer position and an error surface estimation may be performed at last to find an optimal MVD with 1/16 precision.
         1) In one example, M may be 3.
         2) In one example, only integer-pel search may be performed.
         3) In one example, only integer-pel search and half-pel search may be performed.
         4) In one example, error surface estimation may be performed for fractional pixel search.
   h. In one example, adaptive affine DMVR may be introduced as two new affine merge modes.
      (a) In one example, the two new affine merge modes may share the same affine merge candidate list.
      (b) In one example, the two new affine merge modes may use different affine merge candidate lists.
      (c) In one example, one indication may be used to indicate whether adaptive affine DMVR is used.
      (d) In one example, one indication may be used to indicate which prediction direction is refined.
   i. In one example, adaptive affine DMVR may be introduced as one new affine merge mode.
      (a) In one example, adaptive affine DMVR may be introduced as one new affine merge mode with reference list 0 refinement.
      (b) In one example, adaptive affine DMVR may be introduced as one new affine merge mode with reference list 1 refinement.
      (c) In one example, adaptive affine DMVR may be introduced as one new affine merge mode with reference list X (X is 0 or 1) refinement.
         1) In one example, X may be derived based on some coding information.
      (d) In one example, one indication may be used to indicate whether adaptive affine DMVR is used.
      (e) In one example, it may be inferred at decoder to determine the prediction direction to be refined.
         1) For example, the cost of refining L0 and the cost of refining L1 may be calculated and/or compared.
   i. In one example, the prediction direction with a smaller cost may be selected to be refined.
      2) For example, the cost of refining L0, the cost of refining L1 and the cost of refining L0 and L1 may be calculated and/or compared.
   i. In one example, the prediction direction with the smallest cost may be selected to be refined.
   j. In one example, affine merge candidates for the new affine merge (i.e., adaptive affine DMVR) modes may be derived from at least one of the inherited affine merge candidates from adjacent neighbors, inherited affine merge candidates from non-adjacent neighbors, constructed affine merge candidates from adjacent neighbors, constructed affine merge candidates from non-adjacent neighbors, history-affine-parameter-based affine merge candidates, regression-based affine merge candidates, pair-wised affine merge candidates.
      (a) In one example, affine merge candidates for the new affine merge (i.e., adaptive affine DMVR) modes may need to meet DMVR conditions and then be added into a new affine merge (i.e., adaptive affine DMVR) candidate list.
      (b) In one example, the affine merge index of adaptive affine DMVR may be coded the same as the affine merge index of regular affine merge mode.
      (c) In one example, the affine merge index of adaptive affine DMVR may be coded different from the affine merge index of regular affine merge mode.
   k. In one example, a subset of or all the subblocks of current block may be used for bilateral matching cost calculation.
      (a) In one example, subblock may be the affine subblock with size of 4×4.
   l. In one example, linear regression may use the refined subblock MVs from adaptive affine DMVR as input and output a set of control-point motion vectors.
      (a) In one example, the output set of CPMVs may be used to derive the regression-based affine merge candidates.
   m. In above examples, the refinement may be invoked only when the affine motion meets the DMVR conditions.
5. In one example, when performing bilateral matching refinement for adaptive affine DMVR, the base MV may be refined and the non-translation parameters may keep unchanged.
   a. In one example, either the motion vector difference of reference list 0 (MVD0) or motion vector difference of reference list 1 (MVD1) of the base MV may be set to zero.
6. In one example, when performing bilateral matching refinement for adaptive affine DMVR, the base MV may be kept unchanged and the non-translation parameters may be refined.
   a. In one example, either non-translation parameters of reference list 0 (NTP0) or non-translation parameters of reference list 1 (NTP1) may be kept unchanged.
7. In one example, when performing bilateral matching refinement for CPMV refinement for adaptive affine DMVR, either the motion vector difference of reference list 0 (MVD0) or motion vector difference of reference list 1 (MVD1) of CPMV may be set to zero.
   a. In one example, when refining one CPMV, the other CPMVs may be fixed.
8. In one example, the operations in bullet 5 or 6 or 7 may be combined.
   a. In one example, when performing bilateral matching refinement for adaptive affine DMVR, the base MV may be refined and the non-translation parameters may keep unchanged, and then the base MV may be kept unchanged and the non-translation parameters may be refined.
   b. In one example, when performing bilateral matching refinement for adaptive affine DMVR, the base MV may be kept unchanged and the non-translation parameters may be refined and then the base MV may be refined and the non-translation parameters may keep unchanged.

### Combined Inter and Intra Prediction (CIIP)

9. In one example, the inter prediction signal in the CIIP mode Pᵢₙₜₑᵣ may be derived using the LIC process.
   a. In one example, it may be applied only if the LIC flag of the corresponding motion is true.
10. In one example, the inter prediction signal in the CIIP mode Pᵢₙₜₑᵣ may be derived using the DMVR process.
   a. In one example, it may be applied only if the DMVR condition of the corresponding motion is met.
11. In one example, the inter prediction signal in the CIIP mode Pᵢₙₜₑᵣ may be derived using the multi-pass DMVR process.
   a. In one example, it may be applied only if the multi-pass DMVR condition of the corresponding motion is met.
12. In one example, the inter prediction signal in the CIIP mode Pᵢₙₜₑᵣ may be derived using the first step of multi-pass DMVR process.
   a. In one example, it may be applied only if the multi-pass DMVR condition of the corresponding motion is met.
13. In one example, the inter prediction signal in the CIIP mode Pᵢₙₜₑᵣ may be derived using the BDOF process.
   a. In one example, it may be applied only if the BDOF condition of the corresponding motion is met.
14. In one example, the operations in bullet 9 or 10 or 11 or 12 or 13 may be combined.
15. A disclosed method on CIIP may be applied to both luma and chroma.
   a. Alternatively, a disclosed method on CIIP may be applied on luma only.

### General Information

16. A syntax element disclosed above may be binarized as a flag, a fixed length code, an EG(x) code, a unary code, a truncated unary code, a truncated binary code, etc. It can be signed or unsigned.
17. A syntax element disclosed above may be coded with at least one context model. Or it may be bypass coded.
18. A syntax element (SE) disclosed above may be signaled in a conditional way.
   a. The SE is signaled only if the corresponding function is applicable.
19. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
20. In above examples, the block may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.
21. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
22. Whether to and/or how to apply the disclosed methods above may be signalled at PB/TB/CB/PU/TU/CU/VPDU/CTU/CTU row/slice/tile/sub-picture/other kinds of region contains more than one sample or pixel.
23. Whether to and/or how to apply the disclosed methods above may be dependent on coded information, such as block size, colour format, single/dual tree partitioning, colour component, slice/picture type.

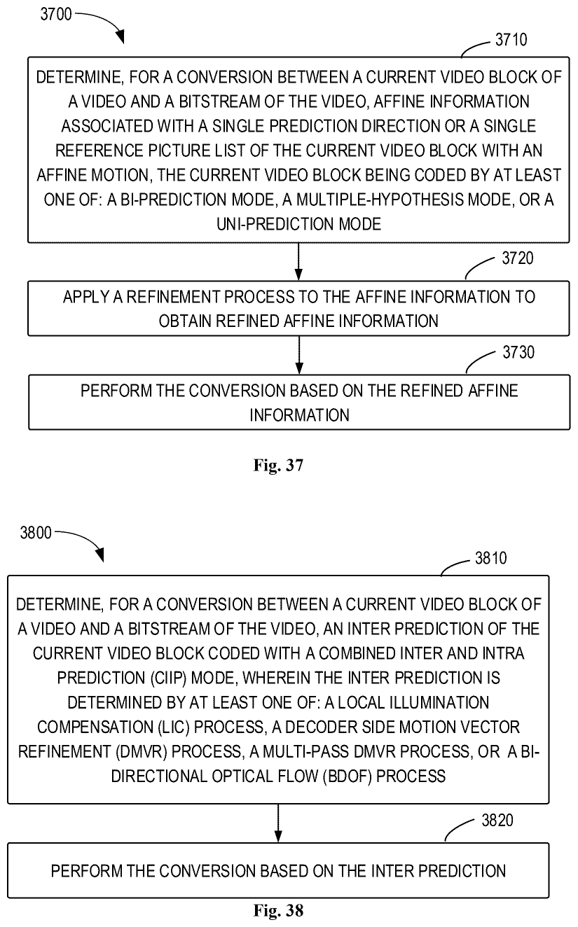

FIG. 37 illustrates a flowchart of a method 3700 for video processing in accordance with embodiments of the present disclosure. The method 3700 is implemented during a conversion between a current video block of a video and a bitstream of the video.

At block 3710, affine information associated with a single prediction direction or a single reference picture list of the current video block with an affine motion is determined. The current video block is coded by at least one of: a bi-prediction mode, a multiple-hypothesis mode, or a uni-prediction mode.

At block 3720, a refinement process is applied to the affine information to obtain refined affine information. For example, affine information for only one prediction direction/one reference picture list even for bi-prediction coded blocks with affine motion is refined. For another example, affine information for only one prediction direction/one reference picture list even for multiple-hypothesis coded blocks with affine motion is refined. For a further example, affine information for uni-prediction coded blocks with affine motion is refined.

At block 3730, the conversion is performed based on the refined affine information. In some embodiments, the conversion may include encoding the current video block into the bitstream. Alternatively, or in addition, the conversion may include decoding the current video block from the bitstream.

The method 3700 enables refining affine information in a single prediction direction or in a single reference picture list. In this way, the coding effectiveness and coding efficiency can be improved.

In some embodiments, the refinement process is based on template matching. For example, template matching may be applied during the refinement process.

In some embodiments, the refinement process comprises an adaptive affine decoder side motion vector refinement (DMVR).

In some embodiments, the adaptive affine DMVR performs a bilateral matching refinement in a single prediction direction for at least one affine bi-prediction merge candidate. For example, adaptive affine DMVR may perform bilateral matching refinement only in one prediction direction for the affine bi-prediction merge candidates.

In some embodiments, the adaptive affine DMVR performs a bilateral matching refinement in one of: a first reference picture list such as L0, or a second reference picture list such as L1.

In some embodiments, the affine information comprises at least one of: a base motion vector of the current video block, at least one non-translation parameter of an affine model of the current video block, or a control-point motion vector (CPMV) of the current video block, and the bilateral matching refinement is for the affine information.

In some embodiments, the bilateral matching refinement is for the base motion vector of the current video block, and the method further comprises: determining one of a first motion vector difference (such as MVD0) for a first reference picture list of the base motion vector or a second motion vector difference (such as MVD1) for a second reference picture list of the base motion vector to be a predefined difference.

In some embodiments, the bilateral matching refinement is for the CPMV of the current video block, and the method further comprises: determining one of a first motion vector difference for a first reference picture list of the CPMV or a second motion vector difference for a second reference picture list of the CPMV to be a predefined difference. For example, the predefined difference may be zero.

In some embodiments, the bilateral matching refinement is for at least one non-translation parameter of the current video block, and at least one first non-translation parameter (such as NTP0) of a first reference picture list or at least one second non-translation parameter (such as NTP1) of a second reference picture list is unchanged.

In some embodiments, a motion vector difference (MVD) searching process is same as a first pass of an adaptive decoder side motion vector refinement (DMVR).

In some embodiments, performing the MVD searching process comprises: determining an integer MVD by looping through a search range based on a square search pattern; and determining an MVD with a predefined precision based on a half-pel search around the integer MVD and an error surface estimation.

In some embodiments, the search range comprises a range of [−M, M], M being a positive integer, the square search pattern comprising an M×M square search pattern, and the predefined precision comprises a 1/16 precision. That is, M×M square search pattern may be used to loop through the search range which is set as [−M, M] to find the best integer MVD. And then half-pel search may be conducted around the best integer position and an error surface estimation may be performed at last to find an optimal MVD with 1/16 precision.

In some embodiments, M may be 3.

In some embodiments, the MVD searching process comprises an integer-pel search. In an embodiment, only integer-pel search may be performed.

In some embodiments, the MVD process comprises an integer-pel search and a half-pel search. For example, only integer-pel search and half-pel search may be performed.

In some embodiments, the error surface estimation is performed for a fractional pixel search.

In some embodiments, an adaptive affine decoder side motion vector refinement (DMVR) comprises a first affine merge mode and a second affine merge mode, the first affine merge mode being associated with a first prediction direction or a first reference picture list, the second affine merge mode being associated with a second prediction direction or a second reference picture list. That is, adaptive affine DMVR may be introduced as two new affine merge modes.

In some embodiments, the first affine merge mode and the second affine merge mode share a same affine merge candidate list.

In some embodiments, a first affine merge candidate list for the first affine merge mode is different from a second affine merge candidate list for the second affine merge mode.

In some embodiments, an indication in the bitstream indicates a prediction direction to be refined. That is, the indication may be used to indicate which prediction direction is refined.

In some embodiments, an adaptive affine decoder side motion vector refinement (DMVR) comprises a single affine merge mode. For example, the adaptive affine DMVR may be introduced as one new affine merge mode.

In some embodiments, the single affine merge mode is associated with a single prediction direction or a single reference picture list.

In some embodiments, the adaptive affine DMVR comprises the single affine merge mode with a target reference picture list refinement, the target reference picture list refinement comprising one of: a first reference picture list refinement or a second reference picture list refinement.

In some embodiments, the target reference picture list refinement is determined based on coding information of the current video block. For example, adaptive affine DMVR may be introduced as one new affine merge mode with reference list X (X is 0 or 1) refinement. X may be determined based on the coding information.

In some embodiments, a target prediction direction to be refined is determined at a decoder for the conversion. For example, it may be inferred at decoder to determine the prediction direction to be refined.

In some embodiments, determining the target prediction direction comprises: determining a first cost for refining a first reference picture list and a second cost for refining a second reference picture list; and determining the target prediction direction based on the first and second costs.

In some embodiments, the target prediction direction comprises a smallest cost among the first and second costs.

In some embodiments, determining the target prediction direction comprises: determining a first cost for refining a first reference picture list, a second cost for refining a second reference picture list and a third cost for refining both the first and second reference picture lists; and determining the target prediction direction based on the first, second and third costs.

In some embodiments, the target prediction direction comprises a smallest cost among the first, second and third costs.

In some embodiments, an indication in the bitstream indicates whether the adaptive affine DMVR is used for the conversion.

In some embodiments, the method 3700 further comprises: determining at least one affine merge candidate for an affine merge mode based on at least one of: an inherited affine merge candidate from an adjacent neighbor of the current video block, an inherited affine merge candidate from a non-adjacent neighbor of the current video block, a constructed affine merge candidate from an adjacent neighbor of the current video block, a constructed affine merge candidate from a non-adjacent neighbor of the current video block, a history-affine-parameter-based affine merge candidate, a regression-based affine merge candidate, or a pair-wised affine merge candidate.

In some embodiments, the method 3700 further comprises: determining whether the at least one affine merge candidate meets at least one condition for decoder side motion vector refinement (DMVR); and in accordance with a determination that the at least one affine merge candidate meets the at least one condition, adding the at least one affine merge candidate into an affine merge candidate list of the current video block.

In some embodiments, the affine merge candidate list comprises an adaptive affine DMVR candidate list.

In some embodiments, the affine merge mode comprises an adaptive affine decoder side motion vector refinement (DMVR) mode.

In some embodiments, coding of a first affine merge index of an adaptive affine DMVR is same as coding of a second affine merge index of a regular affine merge mode.

In some embodiments, coding of a first affine merge index of an adaptive affine DMVR is different from coding of a second affine merge index of a regular affine merge mode.

In some embodiments, a subset of subblocks of the current video block or the subblocks of the current video block is used for bilateral matching cost determination.

In some embodiments, a subblock of the current video block is an affine subblock with a predefined size. By way of example, the predefined size comprises a size of 4×4.

In some embodiments, the method 3700 further comprises: determining at least one refined motion vector (MV) of at least one subblock of the current video block based on an adaptive affine decoder side motion vector refinement (DMVR); determining a set of control-point motion vectors (CPMVs) based on the at least one refined MV of the at least one subblock by using a linear regression.

In some embodiments, the method 3700 further comprises: determining a regression-based affine merge candidate of the current video block based on the set of CPMVs. For example, linear regression may use the refined subblock MVs from adaptive affine DMVR as input and output a set of control-point motion vectors. The output set of CPMVs may be used to derive the regression-based affine merge candidates.

In some embodiments, if at least one condition for decoder side motion vector refinement (DMVR) is satisfied, the refinement process is invoked.

In some embodiments, the refinement process comprises a bilateral matching refinement for adaptive affine decoder side motion vector refinement (DMVR), and performing the refinement process comprises: refining a base motion vector of the current video block without changing at least one non-translation parameter of the current video block.

In some embodiments, one of a first motion vector difference for a first reference picture list of the base motion vector or a second motion vector difference for a second reference picture list of the base motion vector is determined to be a predefined difference. For example, the predefined difference may be zero.

In some embodiments, the refinement process comprises a bilateral matching refinement for adaptive affine decoder side motion vector refinement (DMVR), and performing the refinement process comprises: refining at least one non-translation parameter of the current video block without changing a base motion vector of the current video block.

In some embodiments, at least one first non-translation parameter of a first reference picture list or at least one second non-translation parameter of a second reference picture list is unchanged.

In some embodiments, the refinement process comprises a bilateral matching refinement for adaptive control point motion vector (CPMV) refinement for affine decoder side motion vector refinement (DMVR), and performing the refinement process comprises: determining one of a first motion vector difference for a first reference picture list of a first CPMV of the current video block or a second motion vector difference for a second reference picture list of the first CPMV to be a predefined difference. For example, the predefined difference may be zero.

In some embodiments, the first CPMV of the current video block is refined, and at least one remaining CPMV of the current video block is fixed.

In some embodiments, the refinement process comprises a bilateral matching refinement for adaptive affine decoder side motion vector refinement (DMVR), and performing the refinement process comprises: during a first time duration, refining a base motion vector of the current video block without changing at least one non-translation parameter of the current video block; and during a second time duration after the first time duration, refining the at least one non-translation parameter without changing the base motion vector.

In some embodiments, the refinement process comprises a bilateral matching refinement for adaptive affine decoder side motion vector refinement (DMVR), and performing the refinement process comprises: during a first time duration, refining at least one non-translation parameter of the current video block without changing a base motion vector of the current video block; and during a second time duration after the first time duration, refining the base motion vector without changing the non-translation parameter.

According to further embodiments of the present disclosure, a non-transitory computer-readable recording medium is provided. The non-transitory computer-readable recording medium stores a bitstream of a video which is generated by a method performed by an apparatus for video processing. In the method, affine information associated with a single prediction direction or a single reference picture list of a current video block of the video is determined. The current video block is with an affine motion and coded by at least one of: a bi-prediction mode, a multiple-hypothesis mode, or a uni-prediction mode. A refinement process is applied to the affine information to obtain refined affine information. The bitstream is generated based on the refined affine information.

According to still further embodiments of the present disclosure, a method for storing bitstream of a video is provided. The method comprises: In the method, affine information associated with a single prediction direction or a single reference picture list of a current video block of the video is determined. The current video block is with an affine motion and coded by at least one of: a bi-prediction mode, a multiple-hypothesis mode, or a uni-prediction mode. A refinement process is applied to the affine information to obtain refined affine information. The bitstream is generated based on the refined affine information. The bitstream is stored in a non-transitory computer-readable recording medium.

FIG. 38 illustrates a flowchart of a method 3800 for video processing in accordance with embodiments of the present disclosure. The method 3800 is implemented during a conversion between a current video block of a video and a bitstream of the video.

At block 3810, an inter prediction of the current video block is determined. The current video block is coded with a combined inter and intra prediction (CIIP) mode. The inter prediction is determined by at least one of: a local illumination compensation (LIC) process, a decoder side motion vector refinement (DMVR) process, a multi-pass DMVR process, or a bi-directional optical flow (BDOF) process.

At block 3820, the conversion is performed based on the inter prediction. In some embodiments, the conversion may include encoding the current video block into the bitstream. Alternatively, or in addition, the conversion may include decoding the current video block from the bitstream.

The method 3800 enables determining the inter prediction for the CIIP mode by the LIC process, the DMVR process, the multi-pass DMVR process, or the BDOF process. In this way, the coding effectiveness and coding efficiency can be improved.

In some embodiments, if a flag of LIC of a corresponding motion of the current video block is true, the inter prediction is determined by the LIC process. For example, it may be applied only if the LIC flag of the corresponding motion is true.

In some embodiments, the LIC process is applied in a low-delay B (LDB) in combination with CIIP mode.

In some embodiments, a picture without backward inter-prediction is a low-delay picture, and in the LDB, a current picture comprising the current video block is a low-delay picture and a picture of count (POC) distance between a nearest reference picture and the current picture is one.

In some embodiments, if a condition for DMVR of a corresponding motion of the current video block is satisfied, the inter prediction is determined by the DMVR process. For example, it may be applied only if the DMVR condition of the corresponding motion is met.

In some embodiments, determining the inter prediction by the multi-pass DMVR process comprises: determining the inter prediction by a first step of the multi-pass DMVR process.

In some embodiments, if a condition for multi-pass DMVR of a corresponding motion of the current video block is satisfied, the inter prediction is determined by the multi-pass DMVR process.

In some embodiments, if a condition for BDOF of a corresponding motion of the current video block is satisfied, the inter prediction is determined by the BDOF process.

In some embodiments, the CIIP mode is applied to a luma component and a chroma component. For example, the method on CIIP may be applied to both luma and chroma components.

Alternatively, in some embodiments, the CIIP mode is applied to a luma component without being applied to a chroma component. For example, the method on CIIP may be applied on luma component only.

According to further embodiments of the present disclosure, a non-transitory computer-readable recording medium is provided. The non-transitory computer-readable recording medium stores a bitstream of a video which is generated by a method performed by an apparatus for video processing. In the method, an inter prediction of a current video block of the video is determined. The current video block is coded with a combined inter and intra prediction (CIIP) mode. The inter prediction is determined by at least one of: a local illumination compensation (LIC) process, a decoder side motion vector refinement (DMVR) process, a multi-pass DMVR process, or a bi-directional optical flow (BDOF) process. The bitstream is generated based on the inter prediction.

According to still further embodiments of the present disclosure, a method for storing bitstream of a video is provided. In the method, an inter prediction of a current video block of the video is determined. The current video block is coded with a combined inter and intra prediction (CIIP) mode. The inter prediction is determined by at least one of: a local illumination compensation (LIC) process, a decoder side motion vector refinement (DMVR) process, a multi-pass DMVR process, or a bi-directional optical flow (BDOF) process. The bitstream is generated based on the inter prediction. The bitstream is stored in a non-transitory computer-readable recording medium.

In some embodiments, a syntax element in the bitstream is binarized as at least one of: a flag, a fixed length code, a Euclidean Geometry(x) (EG(x)) code, a unary code, a truncated unary code, or a truncated binary code, the syntax element comprising an indication or a flag.

In some embodiments, the syntax element is signed or unsigned.

In some embodiments, a syntax element in the bitstream is coded with at least one context model, or bypass coded, the syntax element comprising an indication or a flag.

In some embodiments, the syntax element is included in the bitstream based on a condition.

In some embodiments, the condition comprises that a function associated with the syntax element is applicable.

In some embodiments, the syntax element is at least one of: a block level, a sequence level, a group of pictures level, a picture level, a slice level, or a tile group level.

In some embodiments, the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the current video block comprises one of: a color component, a sub-picture, a slice, a tile, a coding tree unit (CTU), a CTU row, groups of CTUs a coding unit (CU), a prediction unit (PU), a transform unit (TU), a coding tree block (CTB), a coding block (CB), a prediction block(PB), a transform block (TB), a block, a sub-block of a block, a sub-region within a block, or a region that contains more than one sample or pixel.

In some embodiments, information regarding whether to and/or how to apply the method 3700 and/or the method 3800 is included in the bitstream.

In some embodiments, the information is indicated at one of: a sequence level, a group of pictures level, a picture level, a slice level or a tile group level.

In some embodiments, the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the information is indicated in a region containing more than one sample or pixel. For example, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the information is based on coded information. By way of example, the coded information comprises at least one of: a coding mode, a block size, a colour format, a single or dual tree partitioning, a colour component, a slice type, or a picture type.

It is to be understood that the method 3700 and/or the method 3800 can be applied separately, or in any combination. With the method 3700 and/or the method 3800, the coding effectiveness and/or the coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, affine information associated with a single prediction direction or a single reference picture list of the current video block with an affine motion, the current video block being coded by at least one of: a bi-prediction mode, a multiple-hypothesis mode, or a uni-prediction mode; applying a refinement process to the affine information to obtain refined affine information; and performing the conversion based on the refined affine information.

Clause 2. The method of clause 1, wherein the refinement process is based on template matching.

Clause 3. The method of clause 1 or 2, wherein the refinement process comprises an adaptive affine decoder side motion vector refinement (DMVR).

Clause 4. The method of clause 3, wherein the adaptive affine DMVR performs a bilateral matching refinement in a single prediction direction for at least one affine bi-prediction merge candidate.

Clause 5. The method of clause 3, wherein the adaptive affine DMVR performs a bilateral matching refinement in one of: a first reference picture list, or a second reference picture list.

Clause 6. The method of clause 4 or 5, wherein the affine information comprises at least one of: a base motion vector of the current video block, at least one non-translation parameter of an affine model of the current video block, or a control-point motion vector (CPMV) of the current video block, and the bilateral matching refinement is for the affine information.

Clause 7. The method of clause 6, wherein the bilateral matching refinement is for the base motion vector of the current video block, and the method further comprises: determining one of a first motion vector difference for a first reference picture list of the base motion vector or a second motion vector difference for a second reference picture list of the base motion vector to be a predefined difference.

Clause 8. The method of clause 6, wherein the bilateral matching refinement is for the CPMV of the current video block, and the method further comprises: determining one of a first motion vector difference for a first reference picture list of the CPMV or a second motion vector difference for a second reference picture list of the CPMV to be a predefined difference.

Clause 9. The method of clause 7 or 8, wherein the predefined difference comprises zero.

Clause 10. The method of clause 6, wherein the bilateral matching refinement is for at least one non-translation parameter of the current video block, and at least one first non-translation parameter of a first reference picture list or at least one second non-translation parameter of a second reference picture list is unchanged.

Clause 11. The method of any of clauses 1-10, wherein a motion vector difference (MVD) searching process is same as a first pass of an adaptive decoder side motion vector refinement (DMVR).

Clause 12. The method of clause 11, wherein performing the MVD searching process comprises: determining an integer MVD by looping through a search range based on a square search pattern; and determining an MVD with a predefined precision based on a half-pel search around the integer MVD and an error surface estimation.

Clause 13. The method of clause 12, wherein the search range comprises a range of [−M, M], M being a positive integer, the square search pattern comprising an M×M square search pattern, and the predefined precision comprises a 1/16 precision.

Clause 14. The method of clause 13, wherein M is 3.

Clause 15. The method of clause 11, wherein the MVD searching process comprises an integer-pel search.

Clause 16. The method of clause 11, wherein the MVD process comprises an integer-pel search and a half-pel search.

Clause 17. The method of any of clauses 12-16, wherein the error surface estimation is performed for a fractional pixel search.

Clause 18. The method of any of clauses 1-17, wherein an adaptive affine decoder side motion vector refinement (DMVR) comprises a first affine merge mode and a second affine merge mode, the first affine merge mode being associated with a first prediction direction or a first reference picture list, the second affine merge mode being associated with a second prediction direction or a second reference picture list.

Clause 19. The method of clause 18, wherein the first affine merge mode and the second affine merge mode share a same affine merge candidate list.

Clause 20. The method of clause 18, wherein a first affine merge candidate list for the first affine merge mode is different from a second affine merge candidate list for the second affine merge mode.

Clause 21. The method of any of clauses 18-20, wherein an indication in the bitstream indicates a prediction direction to be refined.

Clause 22. The method of any of clauses 1-17, wherein an adaptive affine decoder side motion vector refinement (DMVR) comprises a single affine merge mode.

Clause 23. The method of clause 22, wherein the single affine merge mode is associated with a single prediction direction or a single reference picture list.

Clause 24. The method of clause 22 or 23, wherein the adaptive affine DMVR comprises the single affine merge mode with a target reference picture list refinement, the target reference picture list refinement comprising one of: a first reference picture list refinement or a second reference picture list refinement.

Clause 25. The method of clause 24, wherein the target reference picture list refinement is determined based on coding information of the current video block.

Clause 26. The method of any of clauses 22-25, wherein a target prediction direction to be refined is determined at a decoder for the conversion.

Clause 27. The method of clause 26, wherein determining the target prediction direction comprises: determining a first cost for refining a first reference picture list and a second cost for refining a second reference picture list; and determining the target prediction direction based on the first and second costs.

Clause 28. The method of clause 27, wherein the target prediction direction comprises a smallest cost among the first and second costs.

Clause 29. The method of clause 26, wherein determining the target prediction direction comprises: determining a first cost for refining a first reference picture list, a second cost for refining a second reference picture list and a third cost for refining both the first and second reference picture lists; and determining the target prediction direction based on the first, second and third costs.

Clause 30. The method of clause 29, wherein the target prediction direction comprises a smallest cost among the first, second and third costs.

Clause 31. The method of any of clauses 18-30, wherein an indication in the bitstream indicates whether the adaptive affine DMVR is used for the conversion.

Clause 32. The method of any of clauses 1-31, further comprising: determining at least one affine merge candidate for an affine merge mode based on at least one of: an inherited affine merge candidate from an adjacent neighbor of the current video block, an inherited affine merge candidate from a non-adjacent neighbor of the current video block, a constructed affine merge candidate from an adjacent neighbor of the current video block, a constructed affine merge candidate from a non-adjacent neighbor of the current video block, a history-affine-parameter-based affine merge candidate, a regression-based affine merge candidate, or a pair-wised affine merge candidate.

Clause 33. The method of clause 32, further comprising: determining whether the at least one affine merge candidate meets at least one condition for decoder side motion vector refinement (DMVR); and in accordance with a determination that the at least one affine merge candidate meets the at least one condition, adding the at least one affine merge candidate into an affine merge candidate list of the current video block.

Clause 34. The method of clause 33, wherein the affine merge candidate list comprises an adaptive affine DMVR candidate list.

Clause 35. The method of any of clauses 32-34, wherein the affine merge mode comprises an adaptive affine decoder side motion vector refinement (DMVR) mode.

Clause 36. The method of clause 35, wherein coding of a first affine merge index of an adaptive affine DMVR is same as coding of a second affine merge index of a regular affine merge mode.

Clause 37. The method of clause 35, wherein coding of a first affine merge index of an adaptive affine DMVR is different from coding of a second affine merge index of a regular affine merge mode.

Clause 38. The method of any of clauses 1-37, wherein a subset of subblocks of the current video block or the subblocks of the current video block is used for bilateral matching cost determination.

Clause 39. The method of clause 38, wherein a subblock of the current video block is an affine subblock with a predefined size.

Clause 40. The method of clause 39, wherein the predefined size comprises a size of 4×4.

Clause 41. The method of any of clauses 1-40, further comprising: determining at least one refined motion vector (MV) of at least one subblock of the current video block based on an adaptive affine decoder side motion vector refinement (DMVR); determining a set of control-point motion vectors (CPMVs) based on the at least one refined MV of the at least one subblock by using a linear regression.

Clause 42. The method of clause 41, further comprising: determining a regression-based affine merge candidate of the current video block based on the set of CPMVs.

Clause 43. The method of any of clauses 1-42, wherein if at least one condition for decoder side motion vector refinement (DMVR) is satisfied, the refinement process is invoked.

Clause 44. The method of any of clauses 1-43, wherein the refinement process comprises a bilateral matching refinement for adaptive affine decoder side motion vector refinement (DMVR), and performing the refinement process comprises: refining a base motion vector of the current video block without changing at least one non-translation parameter of the current video block.

Clause 45. The method of clause 44, wherein one of a first motion vector difference for a first reference picture list of the base motion vector or a second motion vector difference for a second reference picture list of the base motion vector is determined to be a predefined difference.

Clause 46. The method of clause 45, wherein the predefined difference comprises zero.

Clause 47. The method of any of clauses 1-46, wherein the refinement process comprises a bilateral matching refinement for adaptive affine decoder side motion vector refinement (DMVR), and performing the refinement process comprises: refining at least one non-translation parameter of the current video block without changing a base motion vector of the current video block.

Clause 48. The method of clause 47, wherein at least one first non-translation parameter of a first reference picture list or at least one second non-translation parameter of a second reference picture list is unchanged.

Clause 49. The method of any of clauses 1-48, wherein the refinement process comprises a bilateral matching refinement for adaptive control point motion vector (CPMV) refinement for affine decoder side motion vector refinement (DMVR), and performing the refinement process comprises: determining one of a first motion vector difference for a first reference picture list of a first CPMV of the current video block or a second motion vector difference for a second reference picture list of the first CPMV to be a predefined difference.

Clause 50. The method of clause 49, wherein the predefined difference comprises zero.

Clause 51. The method of clause 49 or 50, wherein the first CPMV of the current video block is refined, and at least one remaining CPMV of the current video block is fixed.

Clause 52. The method of any of clauses 1-51, wherein the refinement process comprises a bilateral matching refinement for adaptive affine decoder side motion vector refinement (DMVR), and performing the refinement process comprises: during a first time duration, refining a base motion vector of the current video block without changing at least one non-translation parameter of the current video block; and during a second time duration after the first time duration, refining the at least one non-translation parameter without changing the base motion vector.

Clause 53. The method of any of clauses 1-51, wherein the refinement process comprises a bilateral matching refinement for adaptive affine decoder side motion vector refinement (DMVR), and performing the refinement process comprises: during a first time duration, refining at least one non-translation parameter of the current video block without changing a base motion vector of the current video block; and during a second time duration after the first time duration, refining the base motion vector without changing the non-translation parameter.

Clause 54. A method for video processing, comprising: determining, for a conversion between a current video block of a video and a bitstream of the video, an inter prediction of the current video block coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; and performing the conversion based on the inter prediction.

Clause 55. The method of clause 54, wherein if a flag of LIC of a corresponding motion of the current video block is true, the inter prediction is determined by the LIC process.

Clause 56. The method of clause 54 or 55, wherein the LIC process is applied in a low-delay B (LDB) in combination with CIIP mode.

Clause 57. The method of clause 56, wherein a picture without backward inter-prediction is a low-delay picture, and in the LDB, a current picture comprising the current video block is a low-delay picture and a picture of count (POC) distance between a nearest reference picture and the current picture is one.

Clause 58. The method of any of clauses 54-57, wherein if a condition for DMVR of a corresponding motion of the current video block is satisfied, the inter prediction is determined by the DMVR process.

Clause 59. The method of any of clauses 54-58, wherein determining the inter prediction by the multi-pass DMVR process comprises: determining the inter prediction by a first step of the multi-pass DMVR process.

Clause 60. The method of clause 54 or 59, wherein if a condition for multi-pass DMVR of a corresponding motion of the current video block is satisfied, the inter prediction is determined by the multi-pass DMVR process.

Clause 61. The method of any of clauses 54-60, wherein if a condition for BDOF of a corresponding motion of the current video block is satisfied, the inter prediction is determined by the BDOF process.

Clause 62. The method of any of clauses 54-61, wherein the CIIP mode is applied to a luma component and a chroma component.

Clause 63. The method of any of clauses 54-61, wherein the CIIP mode is applied to a luma component without being applied to a chroma component.

Clause 64. The method of any of clauses 1-63, wherein a syntax element in the bitstream is binarized as at least one of: a flag, a fixed length code, a Euclidean Geometry(x) (EG(x)) code, a unary code, a truncated unary code, or a truncated binary code, the syntax element comprising an indication or a flag.

Clause 65. The method of clause 64, wherein the syntax element is signed or unsigned.

Clause 66. The method of any of clauses 1-65, wherein a syntax element in the bitstream is coded with at least one context model, or bypass coded, the syntax element comprising an indication or a flag.

Clause 67. The method of any of clauses 64-66, wherein the syntax element is included in the bitstream based on a condition.

Clause 68. The method of clause 67, wherein the condition comprises that a function associated with the syntax element is applicable.

Clause 69. The method of any of clauses 64-68, wherein the syntax element is at least one of: a block level, a sequence level, a group of pictures level, a picture level, a slice level, or a tile group level.

Clause 70. The method of any of clauses 64-69, wherein the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 71. The method of any of clauses 1-70, wherein the current video block comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

Clause 72. The method of any of clauses 1-71, wherein information regarding whether to and/or how to apply the method is included in the bitstream.

Clause 73. The method of clause 72, wherein the information is indicated at one of: a sequence level, a group of pictures level, a picture level, a slice level or a tile group level.

Clause 74. The method of clause 72 or 73, wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 75. The method of any of clauses 72-74, wherein the information is indicated in a region containing more than one sample or pixel.

Clause 76. The method of clause 75, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 77. The method of any of clauses 72-76, wherein the information is based on coded information.

Clause 78. The method of clause 77, wherein the coded information comprises at least one of: a coding mode, a block size, a colour format, a single or dual tree partitioning, a colour component, a slice type, or a picture type.

Clause 79. The method of any of clauses 1-78, wherein the conversion includes encoding the current video block into the bitstream.

Clause 80. The method of any of clauses 1-78, wherein the conversion includes decoding the current video block from the bitstream.

Clause 81. An apparatus for video processing comprising a processor and a non-transitory memory with instructions thereon, wherein the instructions upon execution by the processor, cause the processor to perform a method in accordance with any of clauses 1-80.

Clause 82. A non-transitory computer-readable storage medium storing instructions that cause a processor to perform a method in accordance with any of clauses 1-80.

Clause 83. A non-transitory computer-readable recording medium storing a bitstream of a video which is generated by a method performed by an apparatus for video processing, wherein the method comprises: determining affine information associated with a single prediction direction or a single reference picture list of a current video block of the video, the current video block being with an affine motion and being coded by at least one of: a bi-prediction mode, a multiple-hypothesis mode, or a uni-prediction mode; applying a refinement process to the affine information to obtain refined affine information; and generating the bitstream based on the refined affine information.

Clause 84. A method for storing a bitstream of a video, comprising: determining affine information associated with a single prediction direction or a single reference picture list of a current video block of the video, the current video block being with an affine motion and being coded by at least one of: a bi-prediction mode, a multiple-hypothesis mode, or a uni-prediction mode; applying a refinement process to the affine information to obtain refined affine information; generating the bitstream based on the refined affine information; and storing the bitstream in a non-transitory computer-readable recording medium.

Clause 85. A non-transitory computer-readable recording medium storing a bitstream of a video which is generated by a method performed by an apparatus for video processing, wherein the method comprises: determining an inter prediction of a current video block of the video, the current video block being coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; and generating the bitstream based on the inter prediction.

Clause 86. A method for storing a bitstream of a video, comprising: determining an inter prediction of a current video block of the video, the current video block being coded with a combined inter and intra prediction (CIIP) mode, wherein the inter prediction is determined by at least one of: a local illumination compensation (LIC) process, a decoder side motion vector refinement (DMVR) process, a multi-pass DMVR process, or a bi-directional optical flow (BDOF) process; generating the bitstream based on the inter prediction; and storing the bitstream in a non-transitory computer-readable recording medium.

### Example Device

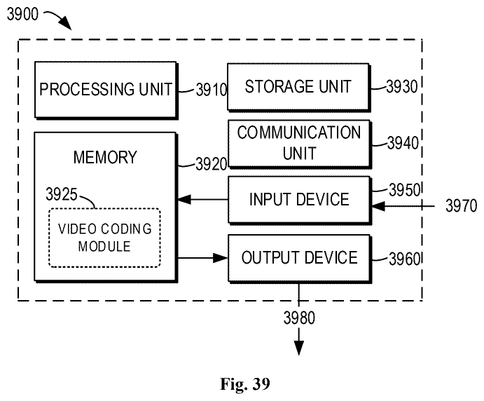

FIG. 39 illustrates a block diagram of a computing device 3900 in which various embodiments of the present disclosure can be implemented. The computing device 3900 may be implemented as or included in the source device 110 (or the video encoder 114 or 200) or the destination device 120 (or the video decoder 124 or 300).

It would be appreciated that the computing device 3900 shown in FIG. 39 is merely for purpose of illustration, without suggesting any limitation to the functions and scopes of the embodiments of the present disclosure in any manner.

As shown in FIG. 39, the computing device 3900 includes a general-purpose computing device 3900. The computing device 3900 may at least comprise one or more processors or processing units 3910, a memory 3920, a storage unit 3930, one or more communication units 3940, one or more input devices 3950, and one or more output devices 3960.

In some embodiments, the computing device 3900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3900 can support any type of interface to a user (such as “wearable” circuitry and the like).

The processing unit 3910 may be a physical or virtual processor and can implement various processes based on programs stored in the memory 3920. In a multi-processor system, multiple processing units execute computer executable instructions in parallel so as to improve the parallel processing capability of the computing device 3900. The processing unit 3910 may also be referred to as a central processing unit (CPU), a microprocessor, a controller or a microcontroller.

The computing device 3900 typically includes various computer storage medium. Such medium can be any medium accessible by the computing device 3900, including, but not limited to, volatile and non-volatile medium, or detachable and non-detachable medium. The memory 3920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3930 may be any detachable or non-detachable medium and may include a machine-readable medium such as a memory, flash memory drive, magnetic disk or another other media, which can be used for storing information and/or data and can be accessed in the computing device 3900.

The computing device 3900 may further include additional detachable/non-detachable, volatile/non-volatile memory medium. Although not shown in FIG. 39, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3940 communicates with a further computing device via the communication medium. In addition, the functions of the components in the computing device 3900 can be implemented by a single computing cluster or multiple computing machines that can communicate via communication connections. Therefore, the computing device 3900 can operate in a networked environment using a logical connection with one or more other servers, networked personal computers (PCs) or further general network nodes.

The input device 3950 may be one or more of a variety of input devices, such as a mouse, keyboard, tracking ball, voice-input device, and the like. The output device 3960 may be one or more of a variety of output devices, such as a display, loudspeaker, printer, and the like. By means of the communication unit 3940, the computing device 3900 can further communicate with one or more external devices (not shown) such as the storage devices and display device, with one or more devices enabling the user to interact with the computing device 3900, or any devices (such as a network card, a modem and the like) enabling the computing device 3900 to communicate with one or more other computing devices, if required. Such communication can be performed via input/output (I/O) interfaces (not shown).

In some embodiments, instead of being integrated in a single device, some or all components of the computing device 3900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3900 may be used to implement video encoding/decoding in embodiments of the present disclosure. The memory 3920 may include one or more video coding modules 3925 having one or more program instructions. These modules are accessible and executable by the processing unit 3910 to perform the functionalities of the various embodiments described herein.

In the example embodiments of performing video encoding, the input device 3950 may receive video data as an input 3970 to be encoded. The video data may be processed, for example, by the video coding module 3925, to generate an encoded bitstream. The encoded bitstream may be provided via the output device 3960 as an output 3980.

In the example embodiments of performing video decoding, the input device 3950 may receive an encoded bitstream as the input 3970. The encoded bitstream may be processed, for example, by the video coding module 3925, to generate decoded video data. The decoded video data may be provided via the output device 3960 as the output 3980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
determining, for a conversion between a current video block of a video and a bitstream of the video, affine information associated with a single prediction direction or a single reference picture list of the current video block with an affine motion, the current video block being coded by a bi-prediction mode;
applying a refinement process to the affine information to obtain refined affine information; and
performing the conversion based on the refined affine information.

2. The method of claim 1, wherein the refinement process comprises an adaptive affine decoder side motion vector refinement (DMVR),
wherein the adaptive affine DMVR performs a bilateral matching refinement in a single prediction direction for at least one affine bi-prediction merge candidate, or
wherein the adaptive affine DMVR performs a bilateral matching refinement in one of: a first reference picture list, or a second reference picture list.

3. The method of claim 2, wherein the affine information comprises at least one of: a base motion vector of the current video block, at least one non-translation parameter of an affine model of the current video block, or a control-point motion vector (CPMV) of the current video block, and the bilateral matching refinement is for the affine information,
wherein the bilateral matching refinement is for the base motion vector of the current video block, and the method further comprises: determining one of a first motion vector difference for a first reference picture list of the base motion vector or a second motion vector difference for a second reference picture list of the base motion vector to be a predefined difference, or
wherein the bilateral matching refinement is for the CPMV of the current video block, and the method further comprises: determining one of a first motion vector difference for a first reference picture list of the CPMV or a second motion vector difference for a second reference picture list of the CPMV to be a predefined difference,
wherein the predefined difference comprises zero.

4. The method of claim 1, wherein a motion vector difference (MVD) searching process is same as a first pass of an adaptive decoder side motion vector refinement (DMVR),
wherein performing the MVD searching process comprises:
determining an integer MVD by looping through a search range based on a square search pattern; and
determining an MVD with a predefined precision based on a half-pel search around the integer MVD and an error surface estimation.

5. The method of claim 4, wherein the search range comprises a range of [−M, M], M being a positive integer, the square search pattern comprising an M×M square search pattern, and the predefined precision comprises a 1/16 precision, wherein M is 3.

6. The method of claim 4, wherein the MVD searching process comprises an integer-pel search, or wherein the MVD process comprises an integer-pel search and a half-pel search.

7. The method of claim 4, wherein the error surface estimation is performed for a fractional pixel search.

8. The method of claim 1, wherein an adaptive affine decoder side motion vector refinement (DMVR) comprises a first affine merge mode and a second affine merge mode, the first affine merge mode being associated with a first prediction direction or a first reference picture list, the second affine merge mode being associated with a second prediction direction or a second reference picture list,
wherein the first affine merge mode and the second affine merge mode share a same affine merge candidate list, or
wherein a first affine merge candidate list for the first affine merge mode is different from a second affine merge candidate list for the second affine merge mode, and/or
wherein an indication in the bitstream indicates a prediction direction to be refined, or
wherein an indication in the bitstream indicates whether the adaptive affine DMVR is used for the conversion.

9. The method of claim 1, wherein an adaptive affine decoder side motion vector refinement (DMVR) comprises a single affine merge mode,
wherein the single affine merge mode is associated with a single prediction direction or a single reference picture list, and/or
wherein the adaptive affine DMVR comprises the single affine merge mode with a target reference picture list refinement, the target reference picture list refinement comprising one of: a first reference picture list refinement or a second reference picture list refinement, wherein the target reference picture list refinement is determined based on coding information of the current video block.

10. The method of claim 9, wherein a target prediction direction to be refined is determined at a decoder for the conversion.

11. The method of claim 10, wherein determining the target prediction direction comprises:
determining a first cost for refining a first reference picture list and a second cost for refining a second reference picture list; and
determining the target prediction direction based on the first and second costs,
wherein the target prediction direction comprises a smallest cost among the first and second costs.

12. The method of claim 10, wherein determining the target prediction direction comprises:
determining a first cost for refining a first reference picture list, a second cost for refining a second reference picture list and a third cost for refining both the first and second reference picture lists; and
determining the target prediction direction based on the first, second and third costs,
wherein the target prediction direction comprises a smallest cost among the first, second and third costs.

13. The method of claim 1, further comprising:
determining at least one affine merge candidate for an affine merge mode based on at least one of: an inherited affine merge candidate from an adjacent neighbor of the current video block, an inherited affine merge candidate from a non-adjacent neighbor of the current video block, a constructed affine merge candidate from an adjacent neighbor of the current video block, a constructed affine merge candidate from a non-adjacent neighbor of the current video block, a history-affine-parameter-based affine merge candidate, a regression-based affine merge candidate, or a pair-wised affine merge candidate;
determining whether the at least one affine merge candidate meets at least one condition for decoder side motion vector refinement (DMVR); and
in accordance with a determination that the at least one affine merge candidate meets the at least one condition, adding the at least one affine merge candidate into an affine merge candidate list of the current video block,
wherein the affine merge candidate list comprises an adaptive affine DMVR candidate list, and/or
wherein the affine merge mode comprises an adaptive affine DMVR mode.

14. The method of claim 13, wherein coding of a first affine merge index of an adaptive affine DMVR is same as coding of a second affine merge index of a regular affine merge mode, or
wherein coding of a first affine merge index of an adaptive affine DMVR is different from coding of a second affine merge index of a regular affine merge mode.

15. The method of claim 1, wherein a subset of subblocks of the current video block or the subblocks of the current video block is used for bilateral matching cost determination,
wherein a subblock of the current video block is an affine subblock with a predefined size, wherein the predefined size comprises a size of 4×4, and/or
wherein the method further comprises:
determining at least one refined motion vector (MV) of at least one subblock of the current video block based on an adaptive affine decoder side motion vector refinement (DMVR);
determining a set of control-point motion vectors (CPMVs) based on the at least one refined MV of the at least one subblock by using a linear regression; and
determining a regression-based affine merge candidate of the current video block based on the set of CPMVs.

16. The method of claim 1, wherein if at least one condition for decoder side motion vector refinement (DMVR) is satisfied, the refinement process is invoked, and/or
wherein the refinement process comprises a bilateral matching refinement for adaptive affine decoder side motion vector refinement (DMVR), and performing the refinement process comprises:
during a first time duration, refining a base motion vector of the current video block without changing at least one non-translation parameter of the current video block; and
during a second time duration after the first time duration, refining at least one non-translation parameter without changing the base motion vector.

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, affine information associated with a single prediction direction or a single reference picture list of the current video block with an affine motion, the current video block being coded by a bi-prediction mode;
apply a refinement process to the affine information to obtain refined affine information; and
perform the conversion based on the refined affine information.

19. A non-transitory computer-readable storage medium storing instructions that cause a processor to perform a method comprising:
determining, for a conversion between a current video block of a video and a bitstream of the video, affine information associated with a single prediction direction or a single reference picture list of the current video block with an affine motion, the current video block being coded by a bi-prediction mode;
applying a refinement process to the affine information to obtain refined affine information; and
performing the conversion based on the refined affine information.

20. A non-transitory computer-readable recording medium storing a bitstream of a video which is generated by a method performed by an apparatus for video processing, wherein the method comprises:
determining affine information associated with a single prediction direction or a single reference picture list of a current video block of the video, the current video block being with an affine motion and being coded by a bi-prediction mode;
applying a refinement process to the affine information to obtain refined affine information; and
generating the bitstream based on the refined affine information.
